(19) United States
(12) Patent Application Publication
(10) Pub. No.: US 2004/0133440 A1
(43) Pub. Date: Jul. 8, 2004

(54) System and method for objectively managing complex familial interactions and responsibilities

(76) Inventors: David B. Carolan, Austin, TX (US); Maria L. Isbell, Austin, TX (US)

Correspondence Address: HULSEY, GRETHER, FORTKORT & WEBSTER, LLP, 8911 N. CAPITAL OF TEXAS HWY., SUITE 3200, AUSTIN, TX, 78759, US

(21) Appl. No.: 10/646,574

(22) Filed: Aug. 22, 2003

Related U.S. Application Data
(60) Provisional application No. 60/405,166, filed on Aug. 22, 2002.

(51) Int. Cl. G06F 17/60

(52) U.S. Cl. 705/1

(57) ABSTRACT

The present invention is a computer-based interactive system that provides tools for divorced parents to manage their parenting responsibilities such as custody arrangements, visitation, child support, and shared medical expenses. With the system of the present invention, parents can share information about schedules, documents, activities and bills via their own secure, personalized website. The present invention also facilitates the assistance to them by attorneys, counselors, and employers. The present invention addresses the needs of all those associated with parenting and divorce and may be available to users according to various service levels.

### TECHNICAL FIELD OF THE INVENTION

The present invention relates generally to scheduling and contact management systems and methods, and more particularly, to a system and method for managing those scheduling, contact management, bill payment, document management, and childcare situations that arise in complex familial relationships.

### BACKGROUND OF THE INVENTION

Over 147 million Americans are currently divorced or separated with over half of all divorces affecting children. Each year over one million new divorces occur. Additionally, estimates show that one out of every three Americans is a step-parent or a step-child living in a blended family. Divorce commonly results in continuing obligations between the spouses, including financial obligations such as child support, health care payments, and alimony, as well as child custody arrangements, visitation scheduling, information sharing, etc. These continuing obligations cause stress for the divorced couple and the children.

The number of post-divorce, computer-literate parents, children and their relations is approaching 51 million people in the United States and is growing by approximately 5 million people each year. To date, no single system addresses the needs to improve interactions for those individuals. What is needed is an online, internet-based system to facilitate the ongoing relationships and obligations of divorced couples to each other and to their children.

### SUMMARY OF THE INVENTION

The present invention is a computer-based interactive system that provides tools for divorced parents to manage their parenting responsibilities such as custody arrangements, visitation, child support, and shared medical expenses. With the system of the present invention, parents can share information about schedules, documents, activities and bills via their own secure, personalized website. The present invention also facilitates the assistance to them by attorneys, counselors, and employers. The present invention addresses the needs of all those associated with parenting and divorce and may be available to users according to various service levels.

According to the present invention, parents can become members of an internet-based system that enables them to manage the scheduling, contact management, bill payment, document management, and care situations that arise in a complex familial relationship. The complex familial relationship may involve coordinating complex and competing schedules of both parents and children, arranging for elder care, coordinating bills and schedules for children away from home at either college or boarding school, or the complexities of post-divorce relationships.

The present invention uses a community portal accessible by a Web Based Browser to enable members to access, manage, and document events associated with parenthood and divorce. The community portal provided by the present invention seamlessly integrates these functions. The portal may be accessed by a secure member login via a secure network or Internet connection. Furthermore, the portal allows members to share selected information with other members within their community. These other members may comprise their spouse or ex-spouse, children, advisors, counselors, instructors, family and friends. The layered sharing of information allows members to effectively and efficiently communicate their needs and schedules.

Since the community portal is web based, the system may be structured such that members do not require any special programs resident on their local computer. Rather, with a secure login, members may access the community portal from any location having web access and a compatible browser.

The present invention fulfills various functional requirements. As such, those requirements form the foundation of the system and method of the present invention. One goal of the present invention is to provide the tools necessary for individuals to manage responsible and accountable parental relationships with their children in order to provide better economic and emotional security for their dependants. This may take place in the context of a college-bound child, children of divorce, or aging family members. To achieve this objective, the present invention provides a web-based community portal that specifically address the problems faced by individuals, parents, children, family, friends, and employers.

The foregoing has outlined rather broadly aspects, features and technical advantages of the present invention in order that the detailed description of the invention that follows may be better understood. Additional aspects, features and advantages of the invention will be described hereinafter. It should be appreciated by those skilled in the art that the disclosure provided herein may be readily utilized as a basis for modifying or designing other structures for carrying out the same purposes of the present invention. Persons of skill in the art will realize that such equivalent constructions do not depart from the spirit and scope of the invention as set forth in the appended claims, and that not all objects attainable by the present invention need be attained in each and every embodiment that falls within the scope of the appended claims.

### BRIEF DESCRIPTION OF THE DRAWINGS

For a more complete understanding of the present invention, and the advantages thereof, reference is now made to the following descriptions taken in conjunction with the accompanying drawings, in which like reference numerals indicate like features and wherein:

FIG. 1 illustrates the many types of Users associated with the present invention;

FIG. 2 depicts the Community Relationships found within the present invention;

FIG. 3 provides a “Domain Overview” that depicts the overall system of the present invention and its functionality at the highest level. Included within the diagram are references to Use Case diagrams provided in FIGS. 4-17. Consequently, this diagram depicts the relationships between individual Use Case diagrams, their functionality, and how they fit into the overall system;

FIG. 4 provides a UML drawing depicting Actors, and a range of roles to be filled by users of the system;

FIG. 5 provides a Use Case diagram for “Browse Member Content” that depicts the functionality available to any member when logged in to the community portal provided by the present invention. This functionality is incorporated into the global navigation or part of the Application Page Framework within the community portal.

FIG. 6 provides the “Work With Calendar” Use Case diagram that depicts the functionality associated with this module of the present invention product. Some Use Cases, such as those related to the Journal, are referenced in other Use Case diagrams.

FIG. 7 provides the “Communicate With Others” Use Case diagram that provides an overview of communications within the present invention. The diagram includes references to the FIG. 8, FIG. 9, and FIG. 10 Use Case diagrams;

FIG. 8 provides the “Work With Inbox” Use Case diagram that depicts the functionality of the Inbox within the present invention;

FIG. 9 provides the “Work With Forums” Use Case diagram that depicts the Discussion Groups functionality within the present invention;

FIG. 10 provides the “Work With Address Book” Use Case diagram that depicts the Address Book functionality within the present invention;

FIG. 11 provides the “Work With Document” Use Case diagram that depicts the functionality of the present invention. Note that some of the Use Cases provided are referenced in other diagrams;

FIG. 12 provides the “Work With Bills” Use Case diagram, which depicts the functionality of the bill paying aspect of the present invention and may require the participation of sub-systems or 3rd party systems;

FIG. 13 provides a “Work With Tutorials” Use Case diagram, which depicts the help functionality of the present invention and includes the perspectives of both Members and Advisors;

FIG. 14 provides a “Work With Employer Tools” Use Case diagram, which further depicts functionality related to the use of the present invention by Employers to manage the employer child support payment process;

FIG. 15 provides a “Publish Content” Use Case diagram, which illustrates the functionality related to the submission and management of content provided by Authors, and the review, approval, and publishing of that content by Editors;

FIG. 16 provides a “Perform Member Administration” Use Case diagram, that shows activities related to the administration of member accounts as may be performed by Help Desk Representatives;

FIG. 17 provides a “Perform System Administration” Use Case diagram, which has activities related to the administration of information systems as may be performed by one or more System Administrators within the system and method provided by the present invention;

FIG. 18 provides a systems overview which illustrates the major components of the present invention, their relationships and dependencies, key system interfaces, and external nodes (or systems); and

FIGS. 19-32 provide prototypical screenshots of various Web Pages provided by the present invention.

### DETAILED DESCRIPTION OF THE PREFERRED EMBODIMENTS

Various service levels may be provided by the system of the present invention to facilitate access, management, scheduling and sharing according to the system and methods of the present invention. One embodiment may be specifically tailored to address the needs of those individuals associated with a divorce (parents, children, family, and advisors), but it should be noted that other embodiments can be tailored to address other complex familial relationships, such as those that have been previously identified. The following is a representative, but non-exhaustive, description of service levels that can be implemented according to the principles of the present invention.

For example, one level of service may bundle electronic payment of child support, personal e-mail, and notification of child support payments. The electronic payment of child support may merely be the facilitation of these payments, rather than actual processing. The e-mail account may have a limited size to motivate the member to upgrade to a higher level of service. The member's employer can also become a user with limited functionality. A system of checks and balances can be provided to ensure that employers do not sign on as employees by ensuring each user has a unique login. Additionally, this first level of service may include access to: public content; e-commerce services for products and promotional items; and searchable lists of local advisors.

A second, higher level of service, may include all of the features of the first level described above and fully customized calendar and scheduling via a “custody wizard” setup; personal document storage and sharing; and electronic sharing and payment of miscellaneous bills. A third party vendor, as known to those skilled in the art, may provide this payment service as is the case for the child support payments discussed above. Instant messaging/chat functions are or may be included to improve communications between parents, their children and related support members. A personal counseling and local resource may provide referrals via telephone and the Internet. This may also be integrated through cooperation with a third-party. Finally, an optional fax service may be bundled into this second level of service.

A third level of service may include all of the features of the first two levels which have been discussed previously, as well as a personal fax number with an e-mail interface to send and receive faxes, and an electronic parenting plan. This electronic parenting plan allows individuals to manage shared schedules, care and finances via a shared calendar and bill payment system.

In addition to various levels of service, there are many member types that can exist within the present invention, wherein those members have varying access to content and available features. The following is a representative, but non-exhaustive, description of the types of memberships that can be created according to the methods of the present invention.

A “limited” member (e.g., a dependent), may access the calendar functions without being able to generate or access a controlled layer such as a custody calendar in the divorced parent situation. In fact, those members may only see a controlled layer, such as the custody layer, when shared with them. The limited members may also access documents, communication modules (Talk—e-mail), instant messaging, and forums or chat rooms), members-only content, dependants only content, and an advisor directory (Advisor tab with search screen). The limited members may see tabs for the remaining products (employers, child support, and bills), but these will contain only the publicly accessible content such as marketing content for these products. A “Limited” member is associated with and created by a “Premium Regular” member.

A second type of member, a “Registered Regular” Member, may have access to Talk (e-mail only), Advisor Directory, Members-only content under Info, and Kids-Only content. They will see tabs for the remaining products (Calendar, Docs, Bills, Child Support and Employers), but these will show only the publicly accessible content for these products.

A third type of member, a “Basic Regular” Member, having an employer provided account, has all the features of the Registered Regular Member. This feature includes: Calendar (with Child Support features, but no custody features) and Child Support, (these members can view employer-paid child support payments). Additionally, these members can see tabs for the remaining product (Docs, Bills, and Employers), but only show the publicly accessible content for these folders. A Basic Regular Member may require a unique number match to employer case records.

A fourth type of member, a “Premium Regular” Member, can enjoy a fee-based membership, that has access to all features of the Basic Regular Member, with enhanced Calendar (to include custody calendar support), enhanced Talk (communication management/instant messaging and chat), enhanced members-only content, document management (with fax as an upgrade option), and bill payment management. In one embodiment these users could also have the ability to register “Limited” members (dependants or children) who are associated with them. Premium members see a tab for the remaining product (Employers), but this link only presents the publicly accessible content for the employers' portion.

A “Registered Advisor” has access to Talk (in a limited capacity only), members-only content in Info, Kids- or Dependent-Only Content, and a listing in the Advisor Directory. “Registered Advisors” see tabs for the remaining products (Calendar, Docs, Bills, Child Support, Advisors, and Employers), but these tabs show only the publicly accessible marketing content for these modules.

A “Basic Advisor” Member, is also a feature-limited advisor account, with access to all the features of the Registered Advisor Membership, Calendar (without custody or child support, except as shared by “Regular” members in their personal community), Docs (within potential fax upgrade option), enhanced Talk (that includes instant messaging and chat Forums), and “Basic” Advisor Tools. “Basic Advisors” see a tab for the remaining products (Child Support, and Employers), but they will show only the publicly accessible marketing content for the products if they are not logged in. Basic Advisors will be able to search for local advisors if they are logged in.

A “Premium Advisor” Member has a full-featured advisor account with the access as a Basic Advisor Membership, with enhanced Advisor Tools, and an enhanced listing in the Advisor Directory.

An “Employer” Member has access to Calendar (without custody calendar, and with child support events (as a summary representation of those they pay)), Talk (E-mail only; no instant messaging and no Forums), Docs (with fax as an upgrade option), member's only content, and Kids-Only content. These members see tabs for the other products (Advisors, Child Support, Bills) but these links only display the publicly accessible content for those products. Although “Employer” members represent a single class of users with common product features, at least one user account for each Employer membership must have Employer Admin rights, which will include the ability to add sub-users to the Employer membership.

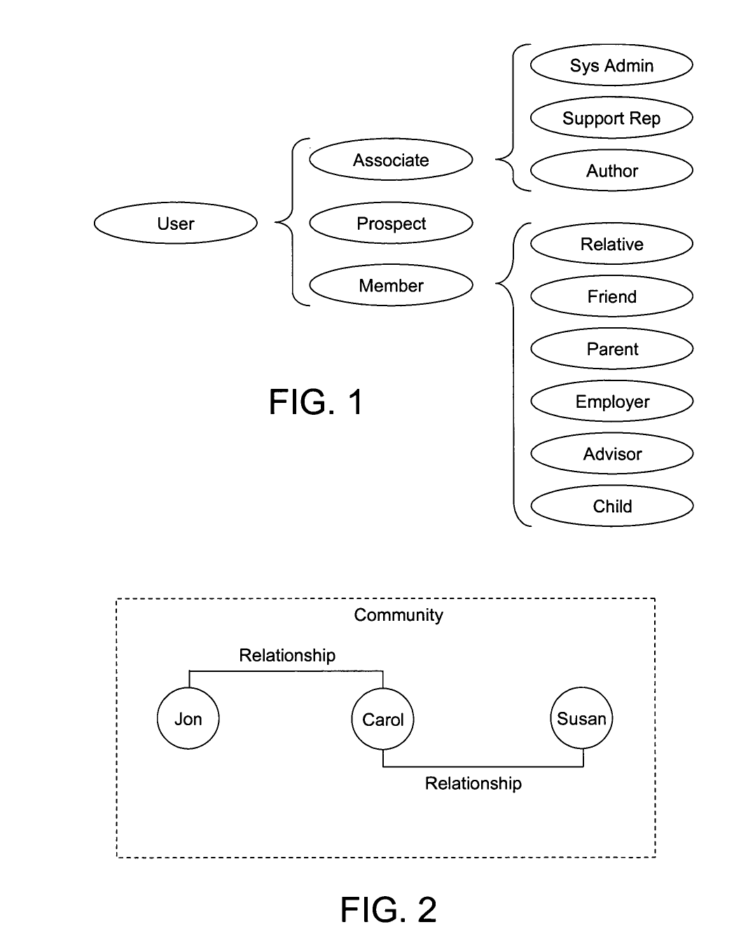

Users of the community portal, as shown in FIG. 1, can be classified in one of three primary types: prospects; members, or associates. Prospects represent users such as visitors to the commonly portal who are not yet members. A prospect can view all public content and information and may elect to join as a member. Members, as described previously, comprise the various member types that have joined at any membership level and therefore have a unique member account. Members can log onto the system and access the services according to their membership level. An associate is any user involved in the administration or internal support of the system and method of the present invention, or its associated content. These user classes depicted in FIG. 1 provide examples of various roles for each classification. Thus, for example, an associate may be system administrator, support representative, or author of site content. A member may be a relative, friend, parent, employer, advisor or child.

The global community within the community portal consists of all members, regardless of their membership type. At each membership level, members are afforded access to certain community services; however, the extent of service availability is limited according to the individual member's membership level.

Within the global community exist many smaller personal communities. A personal community comprises a group of people known to an individual member and with whom the member may interact on a frequent basis. The most obvious example of a personal community may be a single member with his or her family and advisors. Members of an individual's personal community can participate in activities where individual access rights and permissions are assignable by members, such as calendar sharing and document sharing. Members join another's personal community only by invitation. Thus, members are able to invite others (including non-members) to join their personal community. Invited non-members must become global community members, in order to join personal communities. Once they have become global members, they are able to participate in community roles within the personal community of the inviting member.

Each individual member has a personal community of their own, consisting of all members whom they have invited to participate in their personal community, as well as all members whose personal communities they have accepted invitations to join. Therefore, it is conceivable that any individual member may at once be a member of the personal communities of several other members who may or may not be known to each other. However, participation in any member's personal community does not constitute automatic participation in the personal communities of other members to which that individual belongs. All personal communities are mutually exclusive and autonomous. The only relationship that one personal community might have with another would be an indirect relationship where multiple personal communities may have one or more members in common.

To understand this model better, consider the example illustrated in FIG. 2. In this example Jon, Carol, and Susan are all members of the global community. Carol is an attorney and Jon and Susan, who do not know each other, are her clients. Assume for the moment that Jon has invited Carol (his attorney) to join his personal community. Assume also that Carol has invited Susan (her client) to join her personal community.

Under these circumstances, the following rules would apply: (1) Carol is a member of Jon's personal community; (2) Jon and Susan are both members of Carol's personal community; (3) Carol is a member of Susan's personal community; (4) Jon and Susan can both share their calendars and documents with Carol, but Jon can not share his calendar or documents with Susan and vice versa; (5) Carol's personal address book would contain entries for both Jon and Susan, but Jon's personal address book would only contain an entry for Carol; Carol could host a private forum providing access not to the global community, but to all members of her own personal community. (In such a case, Jon and Susan could both post messages and even read messages posted by the other. In such a case, it is conceivable that Susan, having become aware of Jon's existence, could send e-mail directly to Jon); and Carol could host a private forum providing access only to Jon. In this case, Jon and only Jon could read and post messages in the forum.

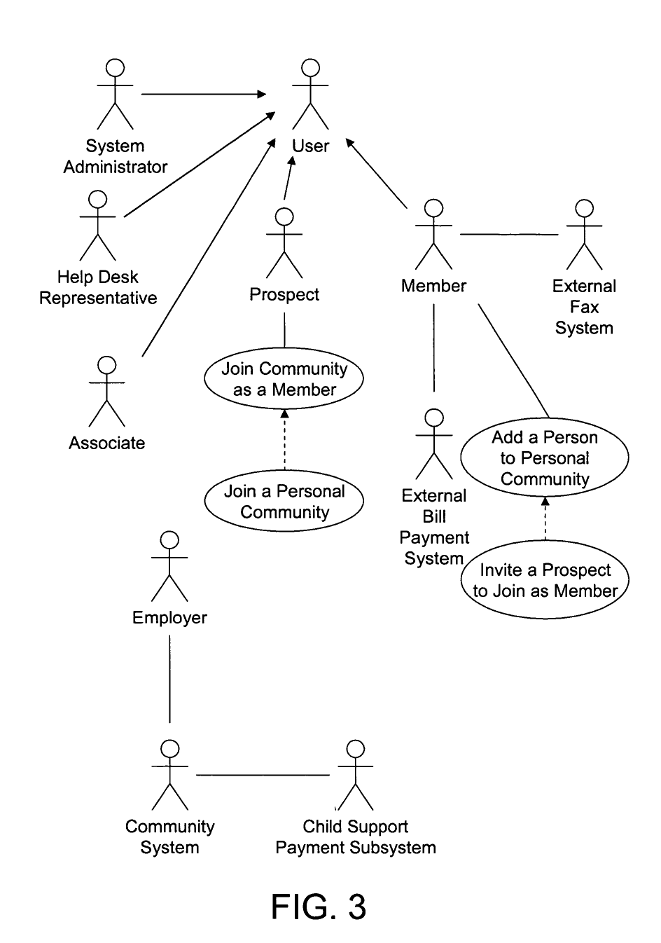

FIGS. 3-17 provide Use Case models that utilize the Unified Modeling Language or UML. While UML provides many different diagrams and forms of notation for modeling, these FIGURES represent many various Use Cases to model the requirements of the system. These diagrams document the many various business rules that may be employed. They are meant to define the essence of the process associated with the present invention. Implementation-specific details may be added after the business rules that define the process are firmly defined. These diagrams describe what is most important: What must happen in the business process associated with the present invention.

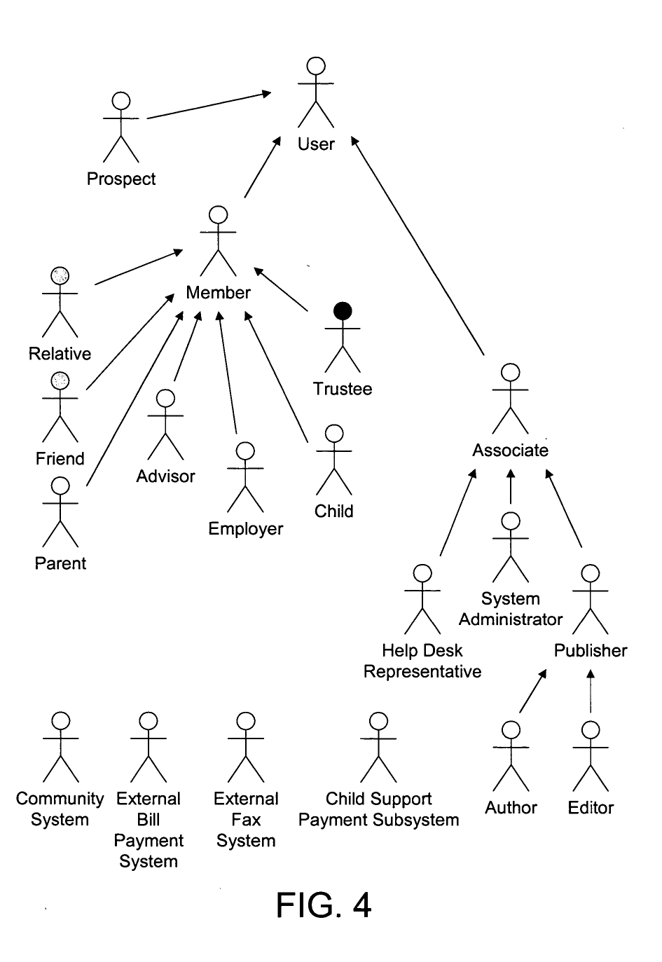

FIG. 3 provides a “Domain Overview” that depicts the overall system of the highest level. This diagram references other Use Case diagrams provided in FIGS. 4-17.

Actors are described in conjunction with FIG. 4. People and external systems that interact with the system and method of the present invention are identified as “actors” within the problem domain. With people, only generalized roles are depicted, not specific individuals. A particular person in life may fulfill one or more roles as depicted by domain actors in the use case diagrams. In use case descriptions, domain actors are presented as proper nouns and are therefore capitalized. Actors are depicted in diagrams as stick-figure people.

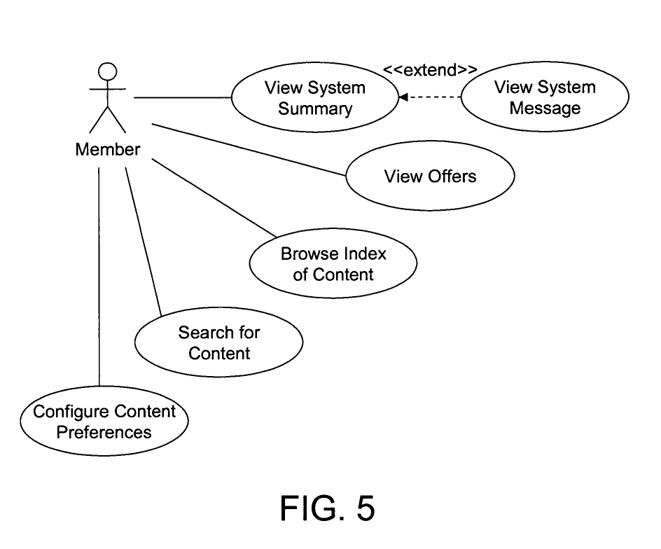

FIG. 5 provides a Use Case diagram for “Browse Member Content” that depicts the functionality available to any member when logged in to the community portal provided by the present invention. This functionality is incorporated into the global navigation or part of the Application Page Framework within the community portal.

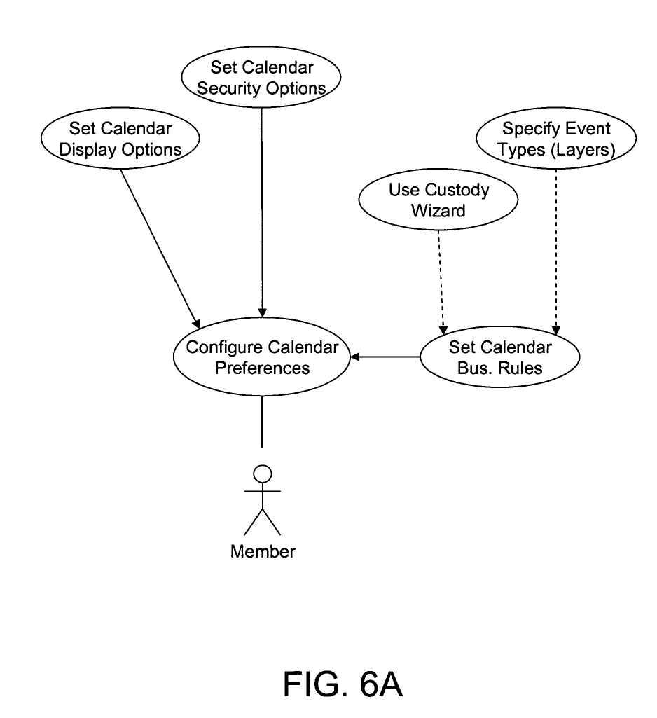

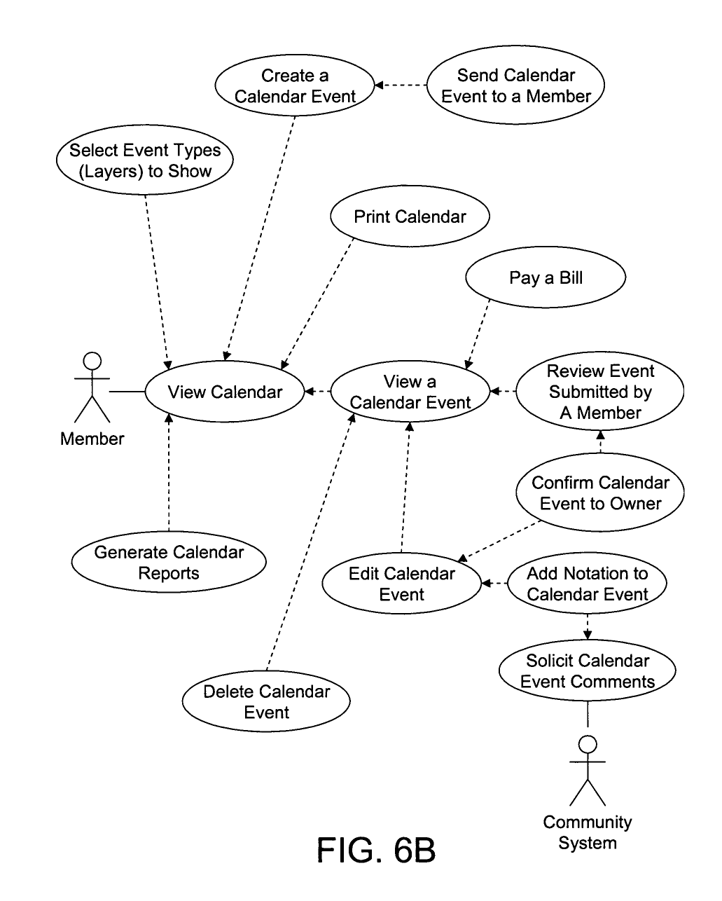

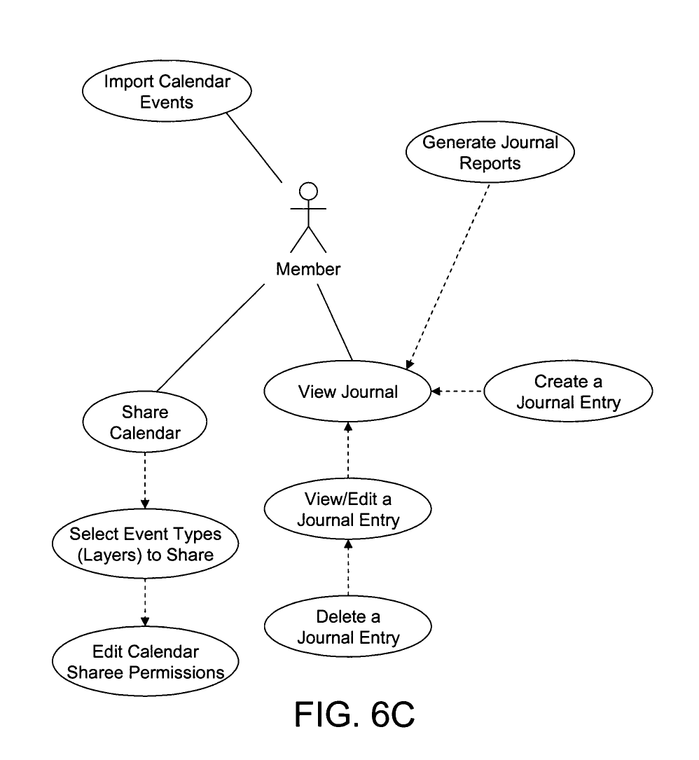

FIG. 6 provides the “Work With Calendar” Use Case diagram that depicts the functionality associated with this module of the present invention product. Some Use Cases, such as those related to the Journal, are referenced in other Use Case diagrams.

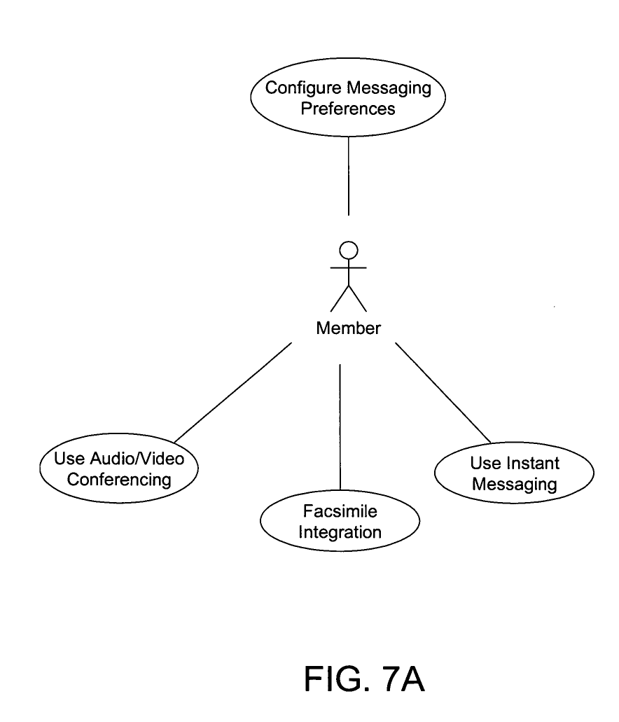

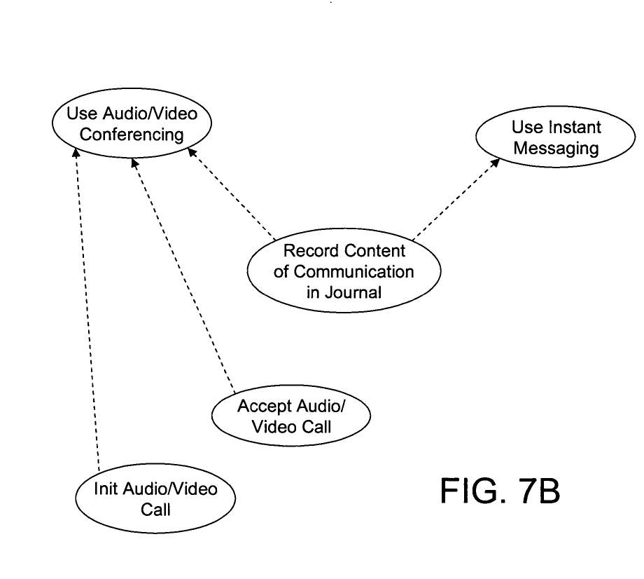

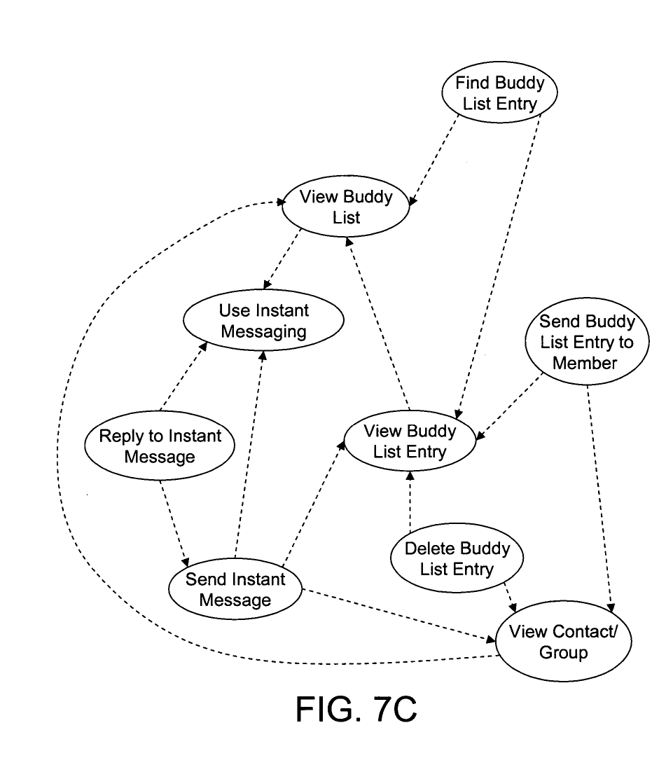

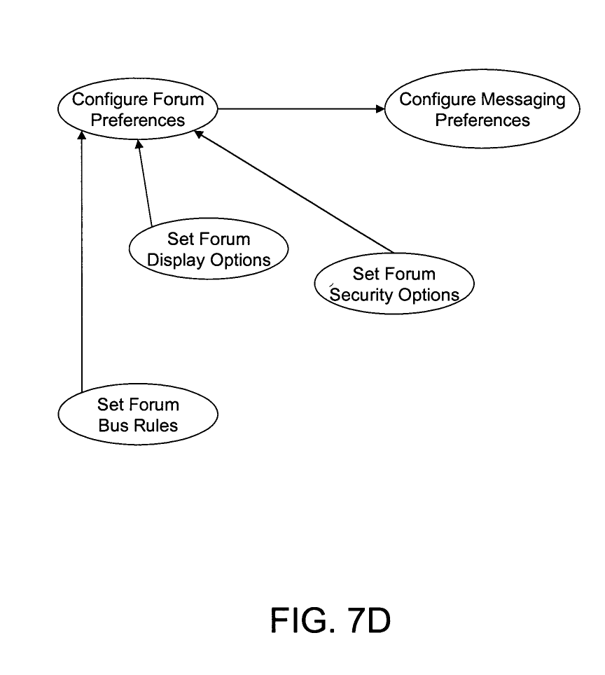

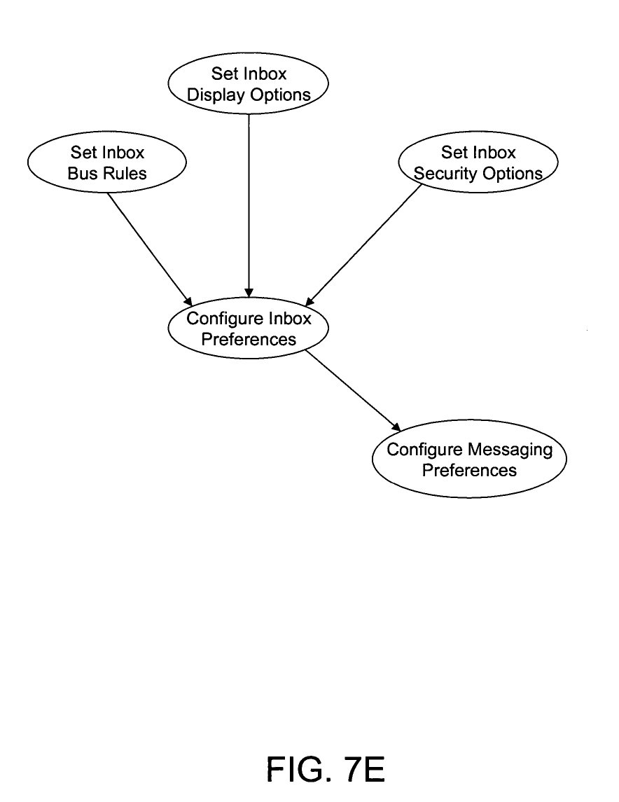

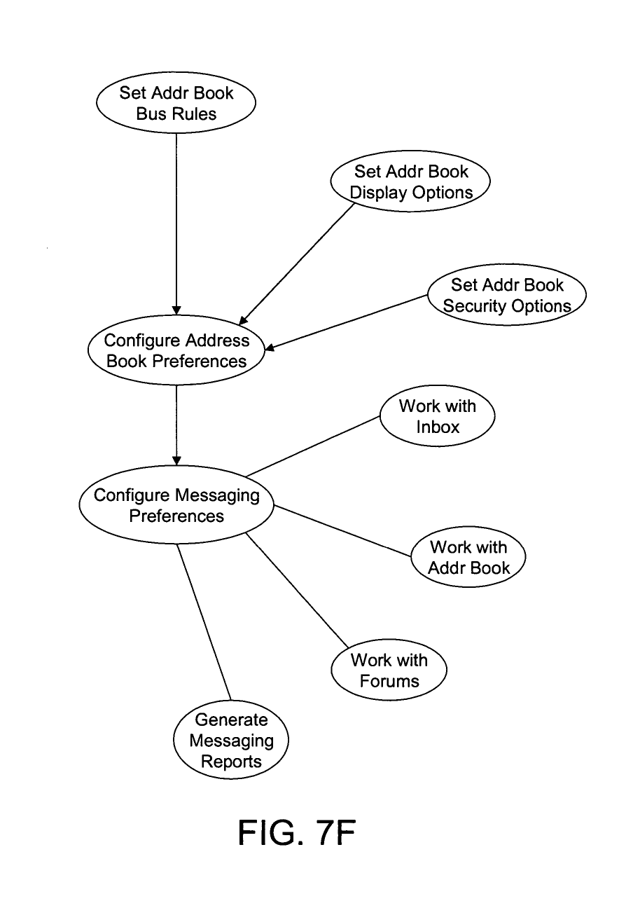

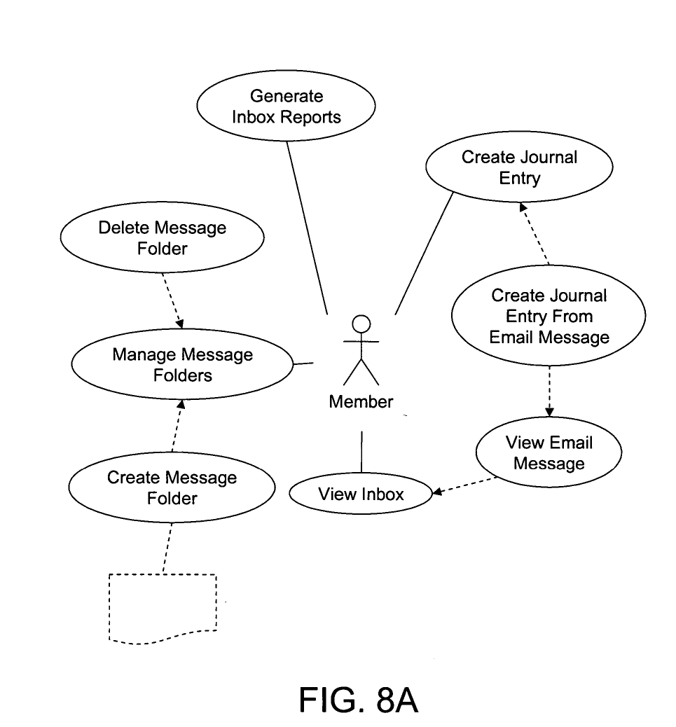

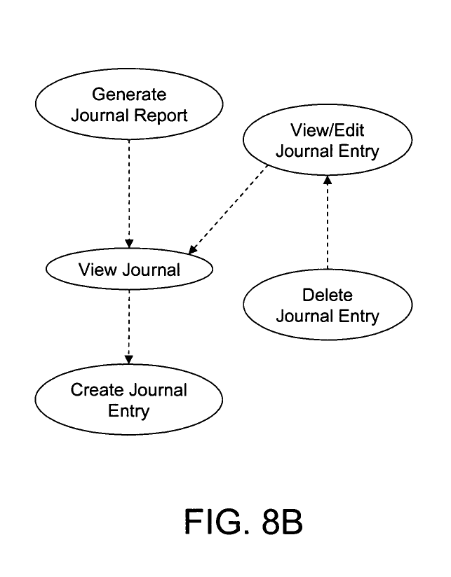

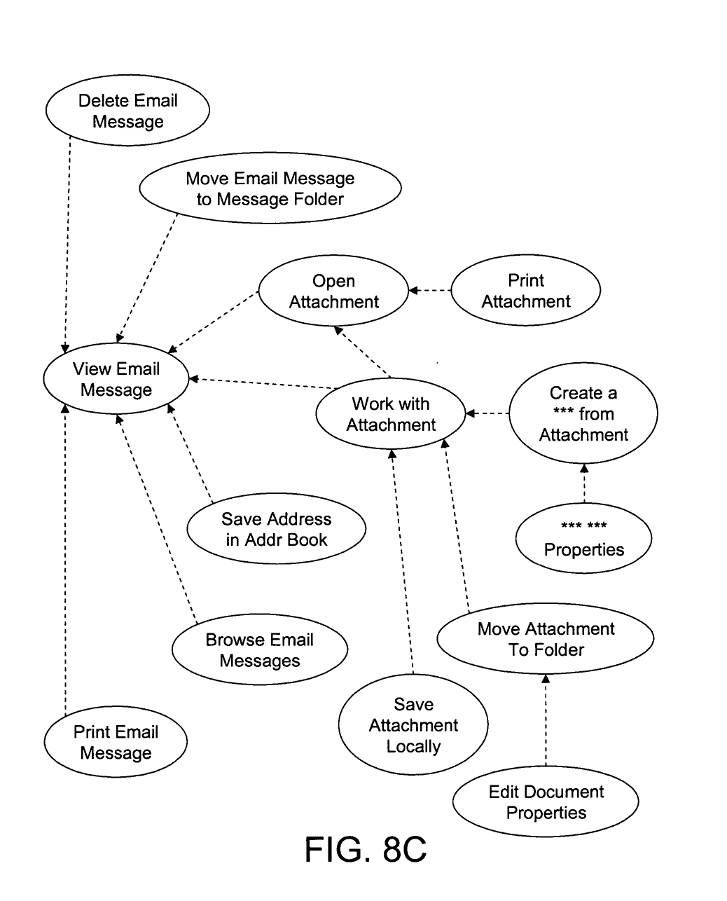

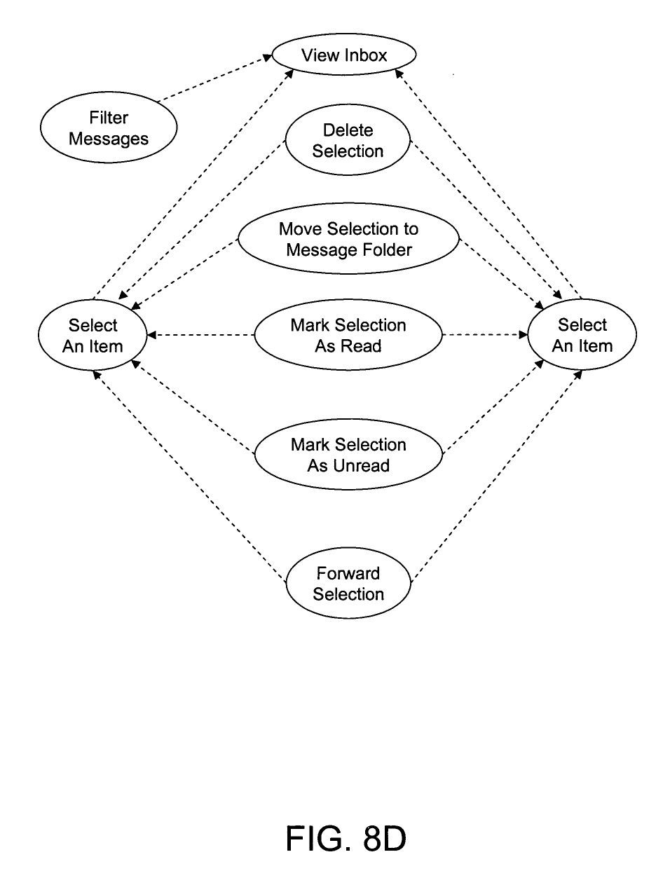

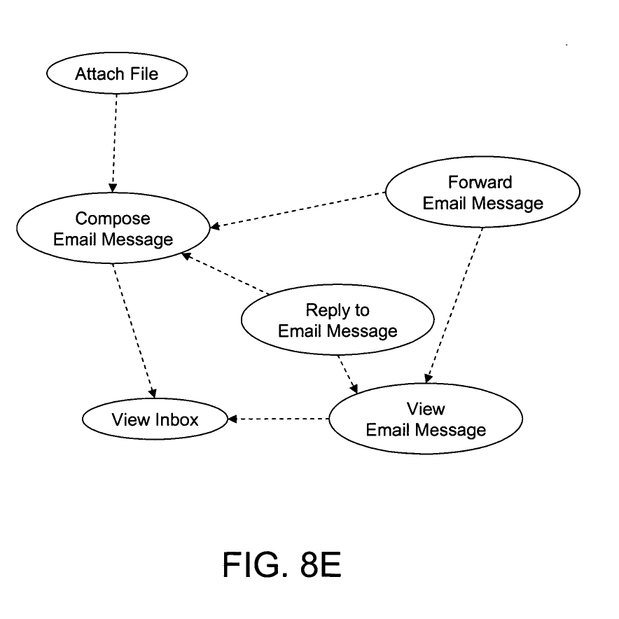

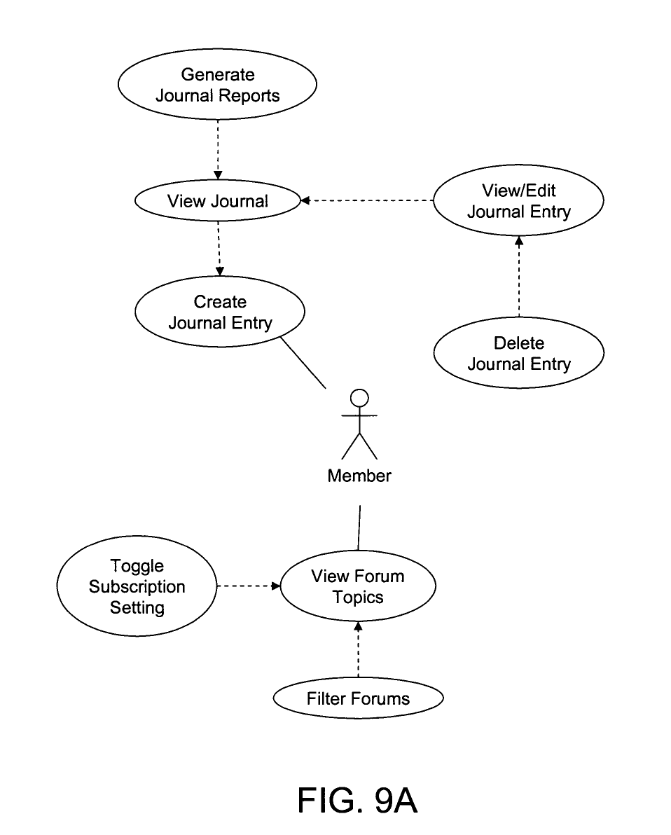

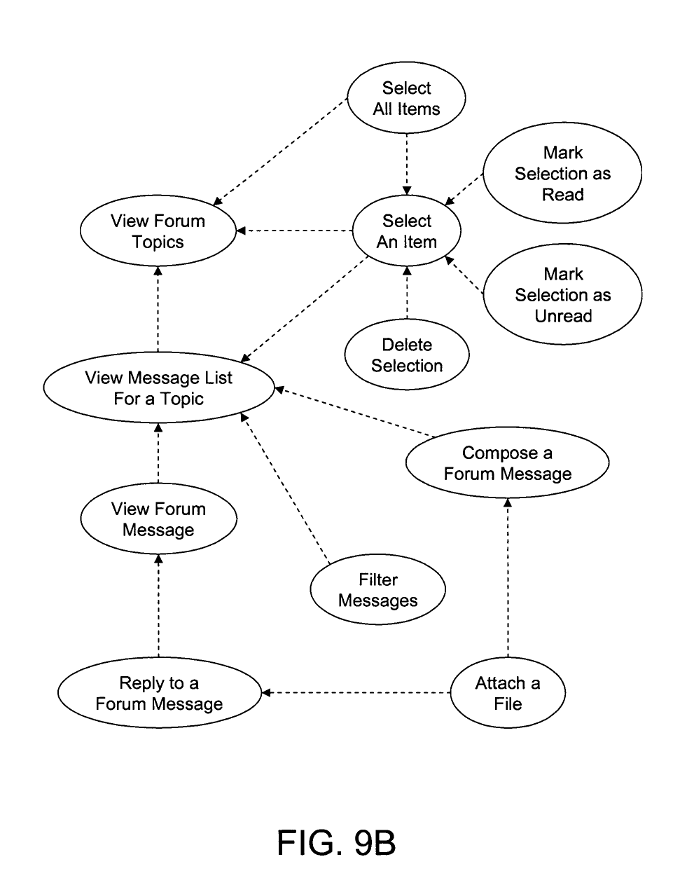

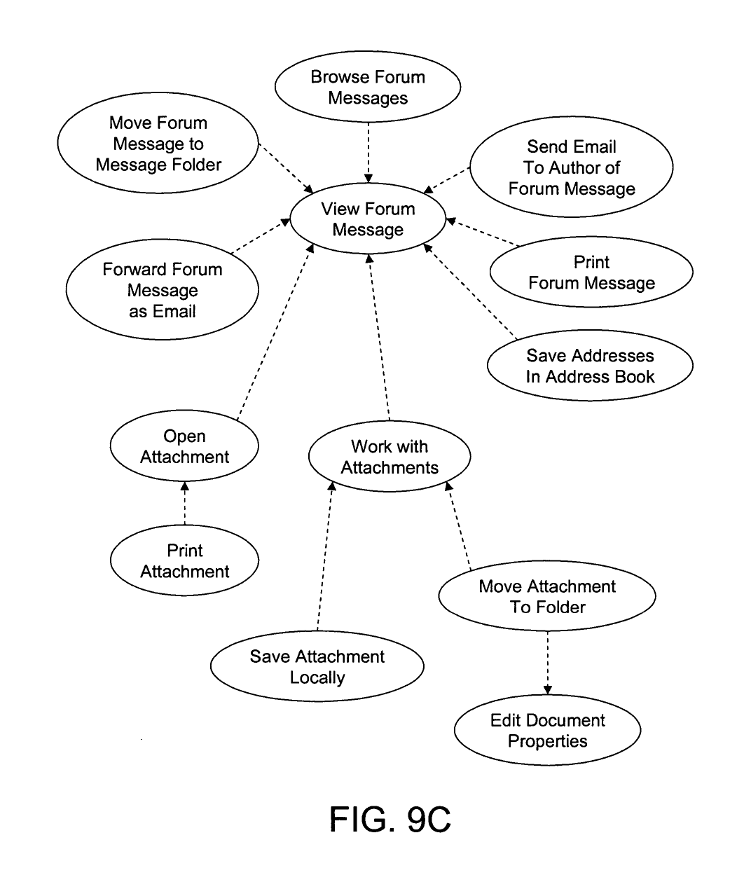

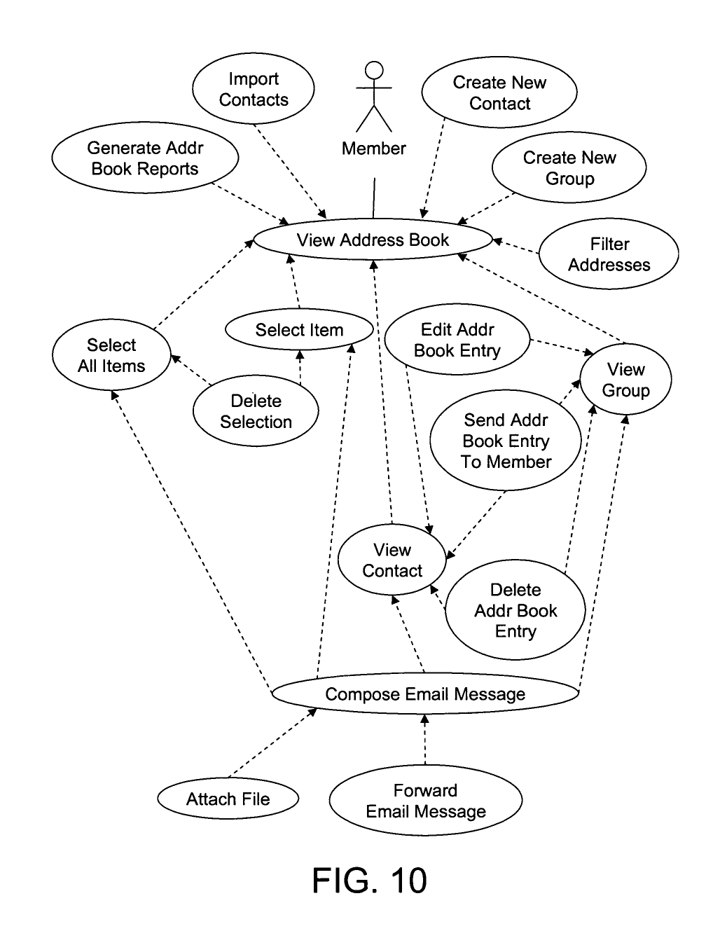

FIG. 7 provides the “Communicate With Others” Use Case diagram that provides an overview of communications within the present invention. The diagram includes references to the FIG. 8, FIG. 9, and FIG. 10 Use Case diagrams.

FIG. 8 provides the “Work With Inbox” Use Case diagram that depicts the functionality of the Inbox within the present invention.

FIG. 9 provides the “Work With Forums” Use Case diagram that depicts the Discussion Groups functionality within the present invention.

FIG. 10 provides the “Work With Address Book” Use Case diagram that depicts the Address Book functionality within the present invention.

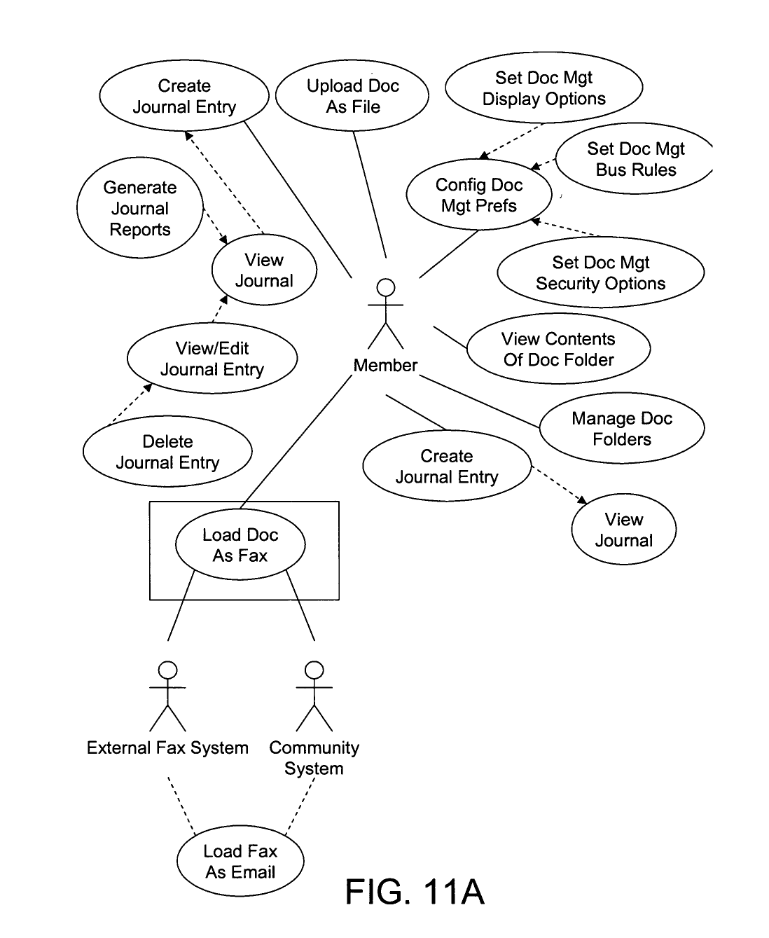

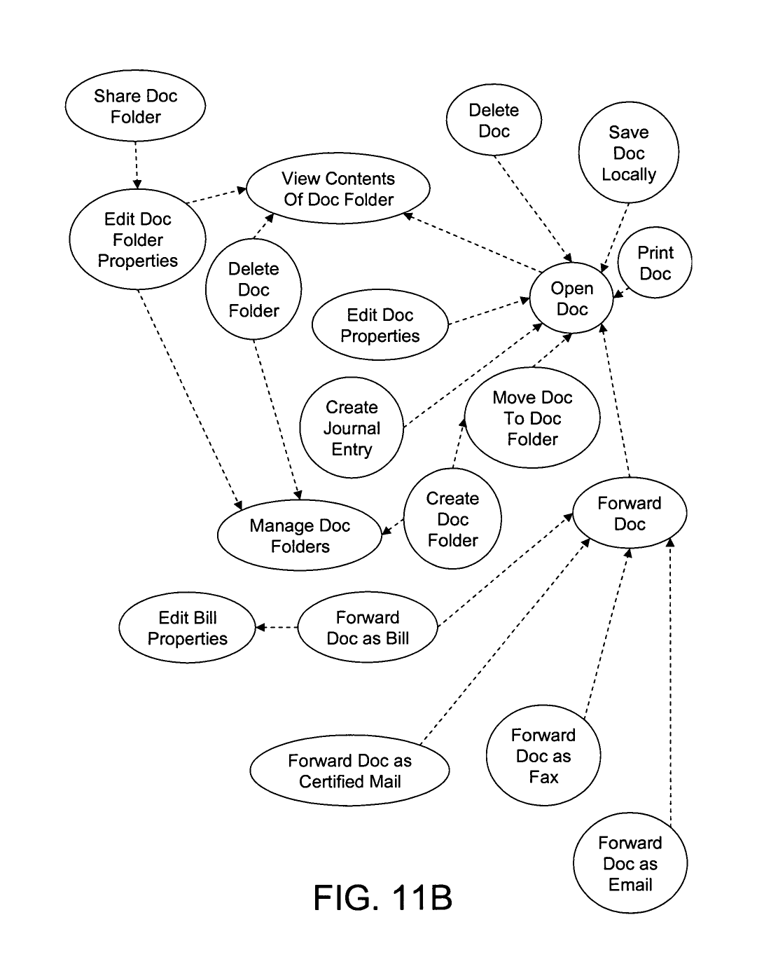

FIG. 11 provides the “Work With Document” Use Case diagram that depicts the functionality of the present invention. Note that some of the Use Cases provided are referenced in other diagrams.

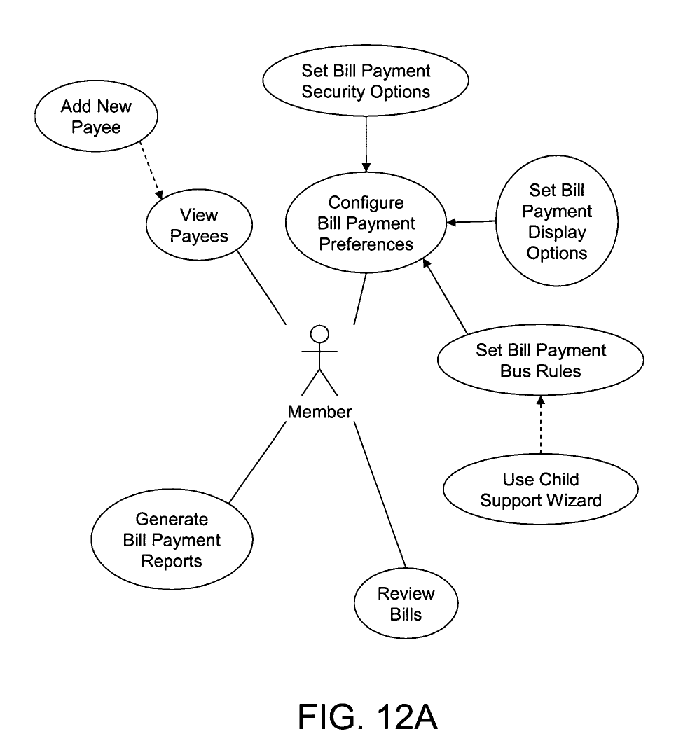

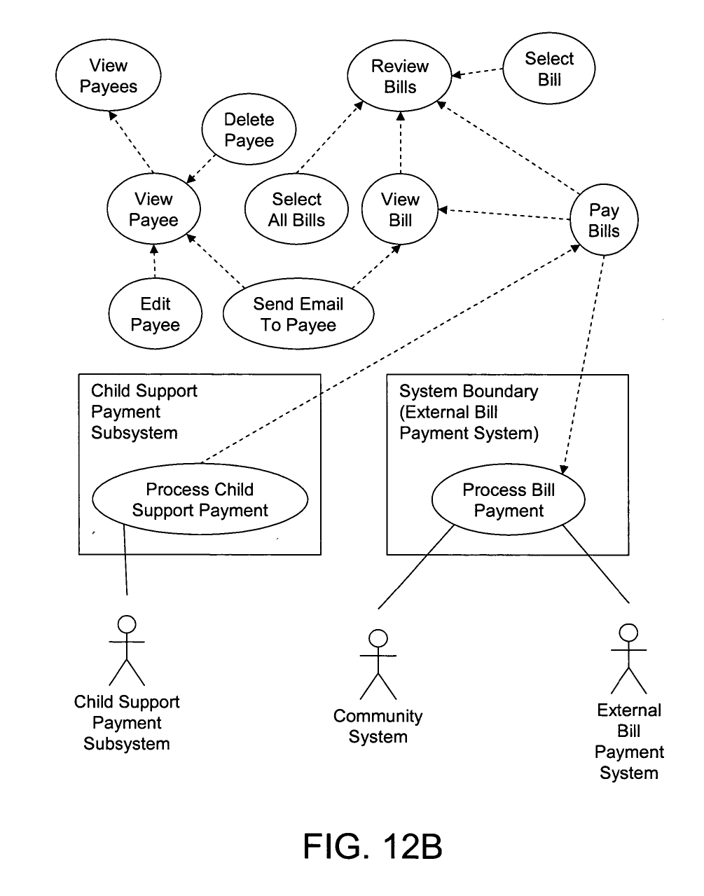

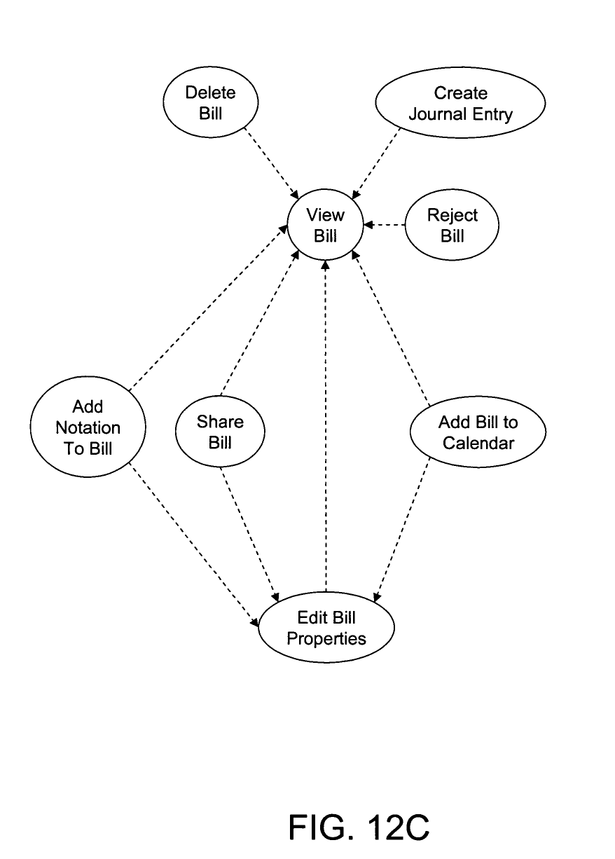

FIG. 12 provides the “Work With Bills” Use Case diagram, which depicts the functionality of the bill paying aspect of the present invention and may require the participation of sub-systems or 3rd party systems.

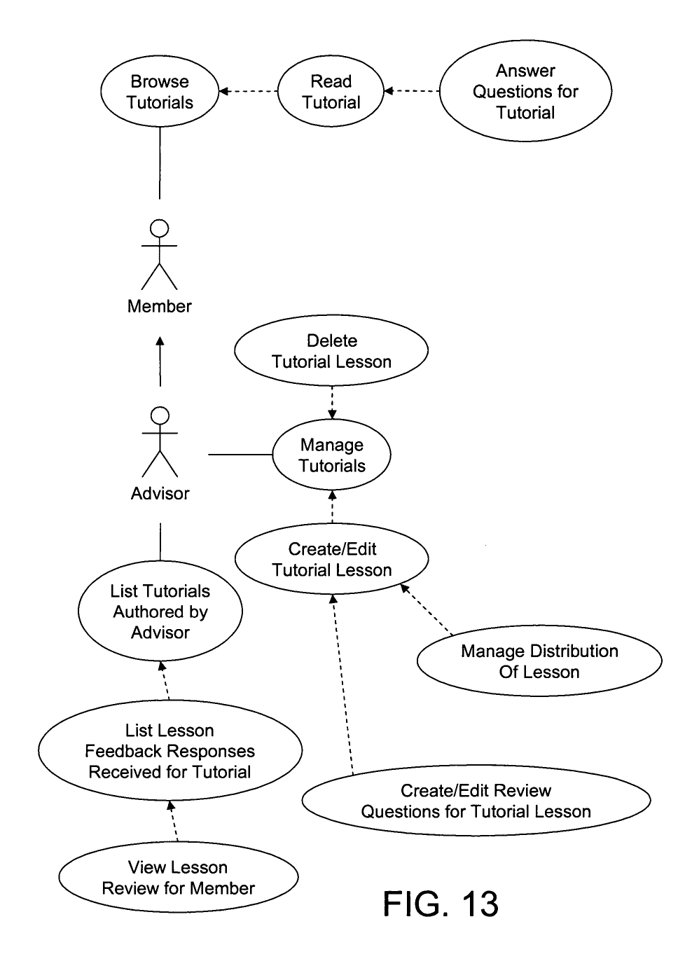

FIG. 13 provides a “Work With Tutorials” Use Case diagram, which depicts the help functionality of the present invention and includes the perspectives of both Members and Advisors.

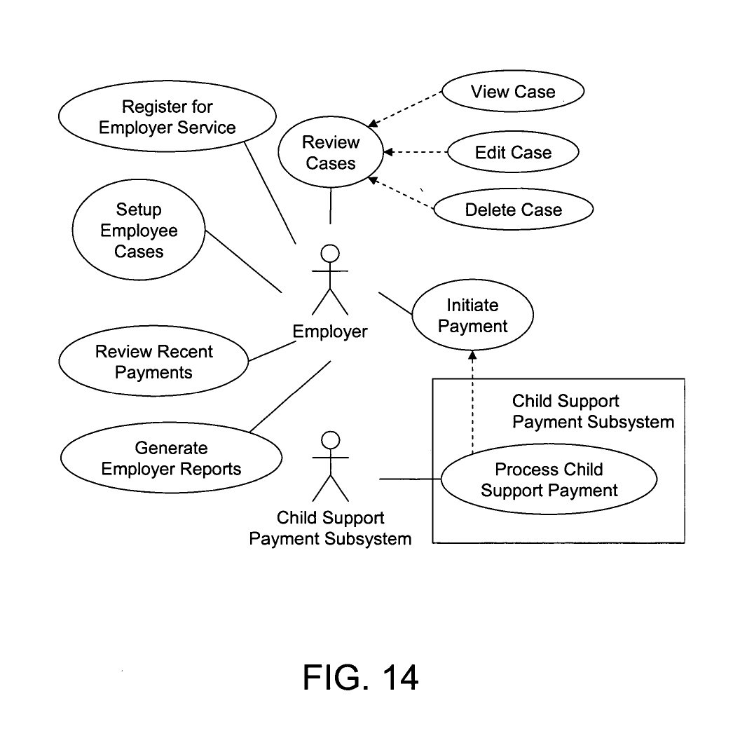

FIG. 14 provides a “Work With Employer Tools” Use Case diagram, which further depicts functionality related to the use of the present invention by Employers to manage the employer child support payment process.

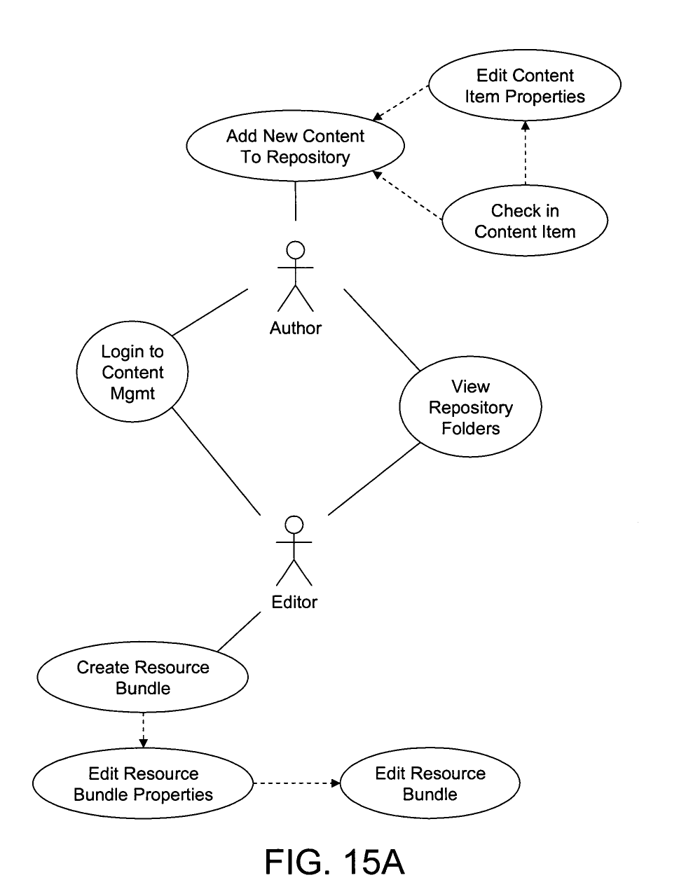

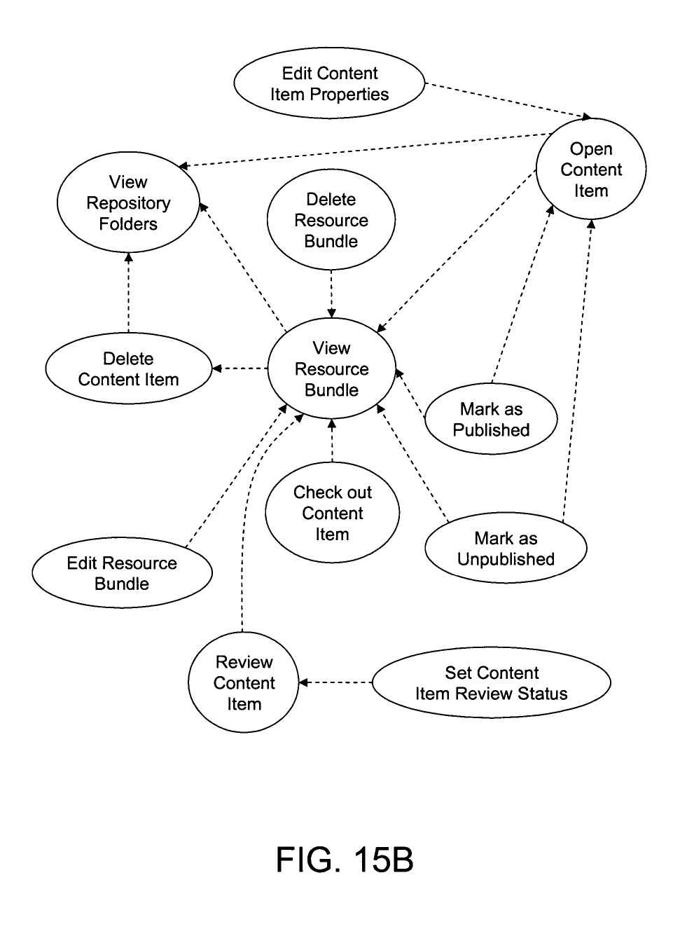

FIG. 15 provides a “Publish Content” Use Case diagram, which illustrates the functionality related to the submission and management of content provided by Authors, and the review, approval, and publishing of that content by Editors.

FIG. 16 provides a “Perform Member Administration” Use Case diagram, that shows activities related to the administration of member accounts as may be performed by Help Desk Representatives.

FIG. 17 provides a “Perform System Administration” Use Case diagram, which has activities related to the administration of information systems as may be performed by one or more System Administrators within the system and method provided by the present invention.

An embodiment of the system and method of the present invention is illustrated in FIG. 18. This diagram illustrates the major components within the present invention, their relationships and dependencies, key system interfacing, and external modes or links. Use Cases describe the way actors interact with and derive value from the system. They are depicted in diagrams as ovals. The associations between actors and use cases and relationships between use cases are depicted graphically in the use case diagrams. Supporting each use case diagram however, is a collection of use case descriptions in separate documents which describe in some detail the normal and exceptional flows, requirements, etc.

To reduce complexity in some diagrams, abstract use cases may be employed. An abstract use case summarizes two or more use cases. An abstract use case is identified in the documentation by the words “Is abstract” which appear in bold type below the use case description. They are also colored gray in the use case diagrams. Each abstract use case is expanded in a separate use case diagram bearing the name of the abstract use case as their title. Abstract use cases can be identified by an association link with a solid white arrowhead pointing from one or more discreet use cases to the abstract use case that is a generalization of them.

UML provides two relationships between use cases—the include relationship, and the extend relationship. Include—allows a use case to always include another use case such that the base case absorbs the behavior of the included case. An include relationship is represented by a dashed arrow labeled ‘include’ pointing from the base use case to the included use case. The flow of events proceeds along in the base use case until the inclusion point is reached. At this point, the flow of events for the included use case is followed until it completes. After completion of the included use case, the rest of the base flow of events is followed to completion. The inclusion is not optional. Extend—allows the extension use case to optionally add its flow of events to the base use cases flow of events. An extend relationship is represented by a dashed arrow labeled ‘extend’ pointing from the extension case to the base use case. The flow of an extension use case may be triggered by user action (optionally) or by the system (conditionally). When a Use Case is extended by the system of FIG. 18, the condition that initiates it may be shown in square brackets adjacent to the ‘extend’ label.

System and administrative management of the community portal provided by the present invention may be centralized and performed by associates or staff. However, the management of individual personal communities within the system is being delegated to the members. An important consideration to note is that while each member can manage their personal community by inviting others to be a member of it, doing so should have little more effect than to add the invited people to a personal community access control list so that they can be included in the assignment of rights to access certain shared resources belonging to the inviting member. Inviting someone to join one's personal community does not itself create a global community account. However, the invited person must have an account in order to join the personal community of any member. Nor should inviting someone to join mean that if that member ever removes the invited member from his or her personal community, that the individual removed should lose their global community account. They merely no longer are able to participate in resource sharing with the member from whose personal community they were removed.

As a final consideration to aid in the understanding of relationships among members who may participate in a personal community, it is clearly understood that “shared” resources such as calendars and file archives should not be considered “common” resources. That is to say, using calendars as an example, that each member interacting in a personal community must have their own unique and completely independent calendar. “Sharing” a resource such as a calendar means allowing some level of access to one's personal calendar. It does not mean that only a single calendar exists to be managed jointly by more than one person. In this way, for example, it would not automatically be the case that an individual could “control” the calendar (or any other resource) of another member. The most they could do would be to “edit” another member's calendar, and then, only if the other member has granted access rights to do so. In the case of a divorce, the custody calendar is a joint resource that is “co-owned” so that once it is created and accepted by all custodial parties, none can terminate their membership accounts and leave the other without access. The custody calendar should survive such occasions in a manner that it is still available to the remaining custodial members. Other situations may arise where a calendar is co-owned and thus should not be limited to the situation involving a divorce.

In one embodiment, the present invention is implemented by a browser-based web application. Thus, the entire community portal and features implemented for prospect, member, and associate user types are implemented within a browser-based web application that does not require client-resident code components beyond a commonly configured web browser.

Although the user interface, in one embodiment, will be implemented in the English language, localized for North America and currency values, where represented, will be in U.S. dollars, there may be a requirement to provide translated user interfaces supporting other languages and currencies as communities and members may extend beyond national boundaries.

Prototypical screenshots of pages within the portal are provided as FIGS. 19-35. The process begins when prospects elect to become members online, or when an existing member invites a prospect to join their personal community.

Prospects join the global community by providing information such as: User Name, Password, Screen Name confirm the usability, First Name, Last Name, Address 1, Address 2 not required, City, State, Zip Code, Country, Telephone Number, Fax Number not required, and E-mail Address not required, membership type. There may also be a hint question and answer. Parents are required to register for children who are less than 13 years of age.

After prospects provide their personal info and select their membership type and level, they may be asked if they wish to use Employer Tools and Advisor Tools. In some embodiments it may not be possible to prevent non-employers from accessing this part of the registration process, but these users will not have the answers to complete it (i.e.—Employer Federal tax ID, Professional License Number). Furthermore, an associate or system administrator should review/approve employer and advisor membership requests. Both factors should help reduce misuse.

When the online registration form is submitted along with promotion code, the membership fee is calculated and shown to the user. The user can then pay using a credit card. Before being allowed to pay, the potential member must first agree to the terms of the membership agreement. The membership agreement will be accessible from within the system at all times as a link included in the footer of every page once the user has logged into the system.

The present invention will capture membership and payment info to include: Member name (login name and user name); Payment amount for each month (This could be tied to membership type); Period of enrollment (After this period, this will default to the regular monthly payment (without promotions) and this will continue month-to-month until user opts out or enrolls for another period of enrollment); Promotion Code (This is valid only during the period of enrollment. This is a percentage of the monthly payment amount. Could be 0% or 100% if it is a free membership); Billed To (This is usually the same person as the member. However in the case of family enrollment, this could be the head of the family. The head of the family could remove this person from the family membership. At that point of time, the member has been removed from the system and is given a 60-day window to register or opt out.); and Member Type—whether advisor, co-parent, children or employer.

The present invention provides for the concept of a family membership. A “family” includes the initial member plus one or more additional members. The initial member is the person who can create and add the other members as part of the family membership. The initial member is responsible for the billing. However, other members can opt out and become separately billed.

When a member invites a prospect to join their personal community. The present invention contacts the prospect via e-mail with an invitation message including registration instructions. If the prospect registers, the system may notify the registration to the member who initiated the invitation. As previously discussed, invitations must come from a member (and not non-members) to another member or a non-member.

Members have many functions available to them based on their membership level. Each has a Personal Address Book that comprises a personal database of contacts for member and associate users. Each member has the ability to create, edit, and delete entries in their personal address book. Individual contact records in an address book should contain the following information: First Name, Last Name, Middle Initial, Title, Company, File As, Business Address Line 1, Business Address Line 2, Business City, Business State, Business Zip Code, Business Phone 1, Business Phone 2, Business Fax, Mobile Phone Number, Pager Number, E-mail Address 1, E-mail Address 2, Web Site Address, Home Address Line 1, Home Address Line 2, Home City, Home State, Home Zip Code, Home Phone 1, Home Phone 2, Birthday, and a Notes field. The address book can have any contacts. For contacts, only the “File As” field is required. Additionally, some embodiments may allow a means by which members can upload and import address book entries from common Personal Information Management systems (i.e.—MS Outlook) or from a suitably formatted file (i.e.—a CSV file compliant with a known specification). Members are also able to create groups within their address books. This feature allows them to quickly address communications such as e-mail messages to multiple people at once. The present invention may provide a means by which groups are quickly and easily created, modified, and deleted. The present invention may provide a means by which members can forward address book entries to other members. Address book entries so forwarded is easily incorporated into the recipient's address book, ideally requiring only the recipient's acceptance of it. This is done in two ways: (1) External forwarding; and (2) Internal forwarding. E-mailing the addresses in the text format is called External forwarding and transfer of data between users is called internal forwarding. Status of address forwarded is indicated as pending, as long as the user accepts or rejects the addresses forwarded.

The present invention may provide a web-based e-mail service for member and associate users. A screenshot of a typical e-mail web page is provided in FIG. 22. All member and associate users have system e-mail accounts. This account may follow the IMAP standard and/or use SMTP for mail delivery outside the community portal. The e-mail feature supports all common e-mail tasks including at minimum composing and sending new messages, replying to messages, and forwarding messages. See FIG. 22. 5 MB may be allocated for every e-mail account and 10 MB to 25 MB is allocated for the documents. If the e-mail space is full for a particular user, a message to the sender may be returned stating that the e-mail space is full and delivery cannot occur.

The total space allocated and total space used and remaining indicates percentage of space used. The space used by each folder is also shown.

The system supports the inclusion of multiple file attachments to an e-mail message. Members are able to upload and attach files from their computer, or from the users personal document archive within the portal. Users are able to open and view attachments within their browser window, provided the attachments are of a suitable format for browser display. Users may download attachments to their computers, or move them to a folder in the personal document archive. File size limitations for attachments may be employed, but this limit is configurable by the system administrator. Virus detection schemes are employed to protect member users from data corruption or loss.

The present invention provides support for organizing e-mail messages into folders. Several fixed folders are required—E-mail, fax, voice-mail, calendar, bills, notifications, offers, sent, drafts, and trash. Other folders may be added as desired at the discretion of the user. Folders are quickly and easily created, deleted, and renamed.

The user's personal address book is accessible from within the e-mail program such that address book entries can be selected when composing and addressing e-mail messages.

Configurable E-mail filtering and rules-based automation allow users to set their individual preferences. Such a feature enables users to direct inbound messages to a specific folder according to such variables as the sender's address, subject, and e-mail content. Users may create as many e-mail rules (filters) as they like. The present invention may provide some means by which committed users of other web-based e-mail clients can access their e-mail from within the community portal environment. Possible approaches include polling such external services if possible. One embodiment may poll up to 3 compatible external POP accounts. The user may provide the POP mail hostname, user account, and password for each as preferences in the mail options. The e-mail inbox should optionally allow users to forward all internal system e-mail and notifications to an external e-mail account. Pre-defined e-mail templates may be made available and can be employed by members to quickly create e-mail messages based on predefined content. This might be useful where it is necessary to provide alternative responses to situations that might otherwise elicit an inappropriate emotional response from a member. And so for example, rather than saying “I hate you, you stupid #&$*!” a member could elect to base their message on a predefined response to say “I'm angry about this. Maybe we can work together to find a solution that satisfies us both.”

The present invention also provides instant messaging features whereby member and associate users can send real-time text messages to one another. For safety purposes, parents can see their children's chat. The present invention will only use HTML chat thus ensuring that no client installation need take place. Similarly, the present invention requires that any instant messaging solution employed (or for that matter, any service included within the present invention) must not require the installation of additional client-side software on the user's computer. The user's personal address book is accessible from within the instant messaging client module such that address book entries can be selected when initiating an instant message. The instant messaging solution supports messaging between several users at once to facilitate group-chat style interaction. Chat between members is limited to one's personal community.

When a person is invited to a personal community and he/she accepts the invitation, that person's profile is added to the address book of the person who invited him/her.

The present invention includes a “buddy list” feature that enables users to maintain an immediately accessible list of their most frequent instant messaging contacts

The present invention allows users to log the time and nature of instant messaging sessions in their personal journal. This journal indicates the type (nature) of the chat (whether it is a group chat or private chat), who was chatting, and time spent online. Additionally, users may record the entire content of instant messaging sessions to their personal journal. If the user does not save the chat, the information will be deleted.

The present invention provides a calendar feature that enables member and associate users to manage their time and important events. A screen shot of the calendar is provided in FIG. 21. This feature enables users to enter, edit, and delete events on their calendar. Calendar events include the following information: Event Description, Date, Time, Duration, Category (such as Business, Personal, Custody Event, Religious, School, Family, Holiday, etc.), and Notes. Users have the ability to add new calendar event categories. Reminders are set to occur at specified intervals before the event start time. Reminders are sent (at users option in preferences) via e-mail to any address specified in the user's calendar preferences and display (at users option in preferences) onscreen in the system summary area. The present invention supports the entry of recurring calendar events, recurring events that have multiple start and stop dates, and periodic exceptions to the recurrence schedule. The screen for creating a recurring event has the event properties and a table for the start and stop dates. Users can add/modify/delete start-stop periods until they are done and then they can click a final save which will store the master event into the database. Overlapping start and stop times are identified and will not be allowed at the time of data entry. Users are informed of conflicts that they must correct to continue. Additionally, users can associate an event with a specific event category. Users are able to create and assign categories at their discretion. Two pre-defined special purpose event categories are supported-child support events and custody events.

There is a daily, weekly and monthly view of the calendar. There is also a facility to edit a single event at a time, allow some events to be repeated, and others to be in pre-defined categories, for example: Custody Event, Religious, School, Family, Holiday, etc. The calendar will display one or more layers at a time depending on the member and their access level to that calendar.

On each page displayed within the calendar is a link, “Calendar Preferences”, with a popup window that has the two-list box transfer mechanism with a checkbox for saving this as the default. Within the calendar users may view either pending or approved events. Pending events are those that have been placed on the calendar, but have not yet been approved. Permanent events are those that have been approved.

Custody Events are shared by divorced parents and used to manage the custody of their children. One person sets a pending custody calendar that must be approved by both. The custody calendar has a fixed end date. This calendar also contains built-in holidays in the database. The database is automatically updated for both Solar and Lunar based holidays. For examples, Muslim holidays using the lunar calendar are not consistent with solar calendar dates.

The calendar also includes “Child Support Calendar Events.” A unique calendar event type is provided for child support events. Such events represent child support payment events, such as a payment that is due, a payment that is made, and a payment that is received.

The present invention also supports a unique calendar event type for custody events. Such events represent the schedule for child custody according to the “custody calendar”. Custody events may be color coded when viewing the Custody Event Layer of any calendar so that, for example, days when a child is in the custody of “Dad” are represented by one color and days when a child is in the custody of “Mom” are represented by another color. The custody calendar supports the tracking and color-coding of custody events for multiple custodians who may all have custodial rights at different times.

The previous point will override any color-coding related issues mentioned here. In one embodiment, only three colors are supported—Mom, Dad and any other custodian. Users can receive additional details by clicking on the event. Calendar layers allow the view of a user's calendar to be customized by enabling or disabling the display of multiple “layers”. Calendar layers correspond to calendar event categories, so a layer will exist for each user-defined event category and for each of the pre-defined categories for child support and custody events.

The present invention provides a means by which members can import calendar events from common personal information management programs (e.g.—MS Outlook). Additionally, users can share their calendar with members of his/her personal community.

The present invention provides a means of calendar access control whereby individual users can elect to allow members of their personal community to access their calendars. Varying levels of access are assignable to other members by calendar event layer, or more discreetly by each individual event. Access levels assignable to layers or single events include: No Access, Read-Only Access, and Read/Write Access. Access level assignments for individual events override assignments for their respective layers.

The present invention provides the ability to share: Entire calendar; 1 or more layers; or 1 or more events. Also, the present invention provides the ability to hide an event. The ability to share may be based on sharing with all persons in the personal community or one or more discrete persons.

Both the parents must agree to custody events prior to them becoming a Permanent event. Prior to that, these events are pending. Users cannot manually override this status. The particular permissions (such as individual or single event) will override the general permissions (such as community or event category).

Access to various events is as follows: No Access—The other user has no access to the layer or event in question; Read-Only Access—The other user can view the layer or event in question, but cannot create or modify events; Read/Write Access—The other user can view the layer or event in question, and can also create and modify events on layers where they have this level of access. Additionally, it is possible for users to add Events to Another Member's Calendar (This is an invitation scenario. Users may submit events for inclusion in the calendar of any member of their personal community who has granted this permission. When a member submits an event to another's calendar, the event should initially be added to the recipient's calendar as a pending event (meaning “unconfirmed”) until the recipient confirms their acceptance of the event. When a user submits an event to another's calendar, the recipient must receive e-mail notification of the event. When the recipient responds to the notification, either by accepting or declining the event, the submitting user is notified of the outcome. If a recipient declines the event, then the pending event is removed from their calendar.

To change Events on Another Member's Calendar, users submit changes to events that they have submitted to another's calendar. When a member submits a change to an event on another's calendar, the event should initially indicate a pending change (meaning “unconfirmed”) on the recipient's calendar until the recipient confirms their acceptance of the change. When a user submits a change to an event on another's calendar, the recipient must receive e-mail notification of the change. When the recipient responds to the notification, either by accepting or declining the change, the submitting user is notified of the outcome by e-mail. If a recipient declines the change, then the pending change should not be made to their calendar and the event should remain on their calendar as it was prior to the pending change.

Users may “hide” events on their calendar such that any event so hidden will not be visible to any other user, even if it exists on a calendar layer that is shared with other users. This will be a checkbox and it will override all other permissions.

Users may print their calendars in multiple views including an entire month, a week, or a single day or NEW Gantt chart. Ads shown in the screen shot and the menu bar may be removed from the printed calendar.

All changes to any shared calendar event are logged to provide a means of reporting those changes to any member on whose calendar the event exists. This log is stored in the System Journal.

Calendar Preferences are quickly and easily managed. Such preferences include the calendar layer access controls as described above, the e-mail address for delivery of event reminders, the startup view (month, week, or day) and layers to show.

Forums allow users to read and post-threaded messages on various topics. The present invention supports both unmoderated forums and moderated forums. However, since only private forums are available, there is no need for moderated forums. Forums allows the inclusion of attachments to posted messages, either by uploading and attaching files of any type, or by attaching files from a member's personal document archive.

As previously stated, documents can be copied to the forum. Any attachment to the forum counts to the space usage of the forum administrator. The only place where a copy of the document will not be made is when a document is shared.

The present invention supports “private” forums hosted by members and shared with others in their personal community. The present invention allows the host member to grant access to forums they host on an individual basis to all members of their personal community or to select members according to their preference. Users can create multiple private forums in his/her personal community.

The present invention provides a means by which members can maintain a personal archive of documents, images, e-mail, etc. stored remotely and accessible by the Web. These documents are stored in Oracle or another like database system. There may be a size limit depending on the physical size of a document that can be uploaded. In one embodiment, all uploads are through HTTP, not through FTP for ease of use. The documents can be organized into folders. Folders are added as desired at the discretion of the user. The present invention provides a means by which folders and nested folders are quickly and easily created, deleted, and renamed.

Users may upload files from their computers to their personal archive. Additionally, received faxes may be included in their personal archive. Documents and faxes can be forwarded from their personal repository by e-mail or fax. This capability is implemented by leveraging a commercial fax gateway. Forwarding documents via fax requires e-mailing them to a specified e-mail address. Attachments are filtered to include only supported file types. The third party fax partner requires a frequently updated list of users identified by their account ID and a PIN number that can be used to validate users prior to granting access to telephone support and also to bill user accounts for faxing services.

The present invention supports the sharing of a user's personal archive with members of his/her personal community. This sharing is controlled by means of access control whereby individual users elect to allow members of their personal community to access resources in their personal archive. Varying levels of access are assignable to other members by folder, or more discreetly by each file individually. Access levels assignable to folders or single files should include: No Access, Read-Only Access, and Read/Write Access. Access level assignments for individual files should override assignments for folders. These access levels may include: No Access—The other user has no access to the folder or file in question; Read-Only Access—The other user can view a folder and its contents or the specific file in question, but cannot create or modify files; and Read/Write Access—The other user can view a folder and its contents or the file in question, and can also create and modify files in folders where they have this level of access. Additionally, users can “hide” files in their archive such that any file so hidden will not be visible to any other user, even if it exists in a folder that is shared to other users.

The present invention provides a means by which members can invite others to join their personal community. Additionally, members are able to permanently remove another from their personal community at any time. Once a member is permanently removed from a member's personal community, it is required that all access rights assigned to that person be retained by the system and recoverable for a limited period of time. However, the removed member may remain in the address book and any historical records of interactions with them (i.e.—e-mail, shared events, instant messaging sessions, etc.) may be retained indefinitely.

Members may temporarily disable the participation rights of any member within their personal community. In this manner, a member is able to temporarily suspend all rights of an individual including their access to all shared resources until they are re-enabled at some future time. When suspending personal community rights in this manner, the system maintains the prior state of all sharing and access rights and privileges so that they can be immediately returned to that prior state upon re-enabling personal community rights.

A central location allows members to easily assign and modify access rights to members of their personal community across all shared applications. In one embodiment, members can see individual access control settings available from contact records in the address book. They should also be accessible in a single location such as “global settings.”

Members may access and modify their own personal profiles that they created at registration. Additionally, the present invention maintains for members a summary of their current activities including: the number of unread e-mails, the number of pending calendar events, the number of unread faxes, the number of unopened voice-mail messages, the number of bills due, and the number of unread offers. This will be one usage metrics. In addition to the above, the system will show the total disk space used for each folder (and Forums) and the total disk space remaining.

Members may cancel their membership in the global community at any time. In the event a member cancels their membership, they lose all rights to access the system but the system retains their data, preferences, and history for a period of time such as 60 days (configurable parameter). In the event the member rejoins the community, all of this information is recoverable so that the member's resources can be returned to their prior state.

The present invention supports the creation, management, sharing, and payment of miscellaneous bills as shown in FIGS. 25, 26 and 27. Bills may be created by at least two methods. In the first method where a physical bill is present, the bill document is scanned and uploaded or faxed into the member's personal file archive. Then entering the bill properties creates a bill. In the second method, a physical bill is not present and the member simply enters the bill properties and the bill record will not contain a viewable representation of the physical bill. The bill image could be multiple attachments, which could be concatenated vertically to show a contiguous image. This image may take the format of GIF, JPEG, TIFF, BMP, or other like file format. When a bill record is created, it contains the following information: Payee, Received Date, Bill Description, Total Amount, Percentage of Amount to be Paid, Amount Due, Due Date, Scheduled Pay Date, Payment Method, and Notes. If a bill represents a child support payment that is due, then its properties are extended to include a Case #, State Disbursement Unit, and whether or not it is paid by an employer. If the bill is to be paid by an employer, the bill is only shown for reference purposes and the member requires no action. Such bills are only read-only. The parenting Plan will also determine preset percentages for certain types of bills discussed in decree such as medical, school expense, extracurricular activities, higher education funding, etc.

The present invention provides a bill reminders feature that will optionally remind members when a bill is due and are paid. Bill reminders will be sent to an e-mail address specified by the member for the purpose of receiving notifications and reminders. Members are able to share bills with other members in their personal community. Bills may be shared in any ratio defined. The amount shared can be specified as a percentage of the original bill or as a fixed amount. When a bill is shared between members, two bill instances are created—one belonging to each of the members. The lifecycle of these independent bill instances are unique and separate. One may be paid independently of the other and vice versa. Parenting Plan will also determine preset percentages for certain types of bills discussed in decree such as medical, school expense, extracurricular activities, higher education funding, etc. Members may accept or decline shared bills in certain instances or embodiments.

The present invention supports an “add to my calendar” property for bills whereby any bill can be added to the member's calendar. When a bill is added to the calendar, a bill payment reminder is added to the calendar before the bill's scheduled pay date. The member in their bill payment preferences bases the lead-time provided by the reminder on the reminder lead-time preference defined.

Members are able to view a list of all bills that are unpaid, those that are scheduled for payment, and a history of those that have been paid. This is illustrated in FIG. 25. Members are able to view the details of a single bill as shown in FIG. 26. If a bill image is available, then it is presented with its accompanying information. Otherwise, only the bill information is presented. FIG. 27 shows an individual bill in detail. Members are able to open and edit the properties of their bills. Members are able to pay their bills online using a variety of payment methods including, but not limited to the following possibilities: major credit cards, wire transfer, electronic funds transfer, and electronic checks. The present invention provides a means by which members can create and manage a collection of payees to whom they may pay bills from time to time as shown in FIG. 27. Members are able to create new payee records by recording the following payee information: Payee Name, Payee Category, Phone, Fax, Address, City, State, Zip Code, E-mail Address, Expense Category, Default Payment Method, Comments and Payor Account Number. The present invention provides a means by which members can review a list of all their payees in FIG. 27. The list should include the following payee information: Payee Name, Payee Category, Phone, Fax, E-mail Address, and any information required to deliver payments (i.e.—ACH Routing Numbers, Bank Account Numbers, Payor Account #, etc.). Members are able to select a single payee to view or edit its properties. Members are also able to delete a payee record at any time; however historical records for bills paid to the payee must not be removed. Members are able to define their preferences relative to bill payment activities. For example, they are able to maintain a list of user-defined payee categories; expense categories, payment methods and accounts, and reminder lead time preferences.

The present invention provides features that enable employers to manage the online payment of child support withholdings. Note that for security reasons these requirements will be supported by an external application built for this purpose and that the application are integrated seamlessly into the rest of the present invention system and user interface. The Child Support system will create ACH payment files that will be uploaded to the ACH network or (at the option of Employer) may be downloaded by the employer member and submitted outside of the system to their own bank. Employer Child Support Payments will be sent via the ACH network to one or more “Disbursement Units”. Disbursement Units generally use a common file format, but because some DUs interpret the formats differently, the system must accommodate a means of providing file-mapping capabilities so that a format can be modified, as necessary, to meet the unique requirements of some DUs. This “file formation map” does not have to be useable or meaningful to associate users, and may instead require the involvement of a more technical resource such as a programmer or administrator. However, it should not be necessary to modify the application source code to accommodate these variations in file formats. When an employer plans to submit payment through our ACH partner, an initial “test” transaction are sent as a “pre-note” transaction or a “zero-dollar” transaction to verify the setup of the employer, and the SDU file formats for the SDUs required. The present invention must hold new employer accounts in a “New” or “Testing” status until manually released by an associate to an “Approved” status before the employer can submit payments. The present invention provides to an associate member (with appropriate access permissions) a view of employer accounts and their test status, and may provide a means by which the associate user can modify their status. Statuses include “New”; “Testing”; “Approved”; and “Hold”. A “hold” status prevents an employer from submitting payments through the system even if they have previously been tested and approved.

The present invention is not required to provide automated handling and resolution of failed test transactions. Failure notice will not be available in the return file from an ACH partner. Failed transactions may be communicated manually by DUs offline and handled manually. The present invention will be generalized to support a concept of Disbursement Units (rather than the more specific “State Disbursement Unit”) to support County Disbursement Units where they exist.

Special provisions are available so that employers can register as members. Employer members provide additional information that is not required for normal membership such as bank account information, additional contacts, and preferred payment method. There is a single “Employer/Company” account with the ability to create two sub-accounts for separately creating and approving payments as a check/balance feature. At employer's option, this check & balance feature could be disabled such that only the single “Employer/Company” account could be used for all purposes. This information augments the existing member record information. Employers are able to setup case records for each employee for whom they withhold and pay child support. Employee case information includes: Employee SSN; Employee ID; E-mail Address; Withholding Amount; Case Number; State Disbursement Unit to Receive Payments (or counties that are supported); (Generalize Disbursement Unitys); FIPS Code; Whether Employee Receives Medical Benefits and provides them to the child; and Whether Employee has been Terminated. An employee record is different from Normal member record. Normal members should have the Employer ID. A SSN match may identify an employee who is already a member. The provision of SSN may be required in order to take advantage of Employer Child Support Payments and to identify duplicate memberships. For cases involving multiple child support payments, there may be multiple case numbers for a given employee.

The present invention provides a means by which employers can upload and import employee case information. The file format for such uploads may vary according to the type of employer. Employers who are processing payments for a single company (one FEIN number) may use one file format while employers or payroll providers who process payments for multiple companies (more than one FEIN number) may use another.

Employers may initiate child support payments by providing a Pay Date, a Settlement Date, and an SDU Deposit Date. Once this required information is provided, employers are able to select specific cases for payment, or optionally, select all cases then initiate payment. Employer's selection is saved and will be repeated accordingly.

The present invention requires a two-step child support initiation and authorization process whereby one user initiates payments and another must authorize them. The present invention provides a means by which employers can view a history of all payments initiated. Such a view should include the status of a payment, the pay date, the settlement date, the withholding amount, the number of cases, the SDU deposit date, and the date the payment was initiated. Employers are able to select a specific payment and view its detail. The present invention provides a view in which employers can view the details of a specific employer payment. Information presented in this view includes: Initiation Date, Pay Date, Settlement Date, SDU Deposit Date, Authorization Number, Person Who Initiated Payment, Person Who Authorized Payment, Employer Bank Account, and the Number of Cases. For each case included in the employer payment, the following information is presented: Case Number, Employee Name, SSN, FIPS Code, SDU, and withholding amount. The view includes a summary of the withholding total, the fee total, and a combined total of funds required for the payment. If the status of the payment is appropriate for such action, employers are able to authorize or stop payments here. Whenever a detailed report is requested then it is secured (compare the member id submitted with the member id stored in the session, we can do a session lookup to implement this).

Members are able to view the histories and status of their own child support payments. However, members are not allowed to view any other information that is related to the employer or to other employee cases.

The present invention also includes a knowledge base or help database that supports basic searches, advanced searching capabilities, and automatic search results ranking. Basic searches are based on single word searches while advanced searches are based on Boolean searches. Knowledge base may be stored as questions and answers where the search is based on questions and answers. The knowledge base includes topics that provide online help to users, facilitating their use of the present invention community portal. The knowledge base may include general topics published and managed by the present invention. Topics may be any information or articles deemed relevant to families in post-divorce situations.

The knowledge base supports the inclusion of interactive media tutorials. The present invention provides online live-agent support via e-mail and the web. Support cases thus initiated may be redirected to telephone via a callback mechanism. Online support case wrap-up is integrated with the knowledge base features so that successfully handled support cases can contribute to the growth and improvement of the knowledge base. This Online Support can itself act like a community. All members can post messages to members in the Online Support community. Frequently Asked Questions in this section may be moved out as an FAQ in the main website. Integrating with third party vendors through parameterized URL can provide this functionality. The present invention provides a means by which associate users can publish and direct content to specific audiences within the global community. Some content, public in nature, will be targeted to all system users, including prospects. However, other content will be for Members Only and targeted to members of the global community. Additionally, some content will be targeted to kids only and published in a sub-site branded and styled for children.

The present invention allows members to maintain a personal journal. Members are able to create, edit and delete journal entries including the following information: Date and Time of Entry, Short Description, Notes, and file attachments. Members are able to produce an onscreen report of journal entries for a date range. Members are able to print the onscreen report at their option. At the user's option, the system should record certain application events in the member journal. When the member sends an e-mail message and elects to record it in their journal, the system should record the date and time the message was sent, the addressee(s), the subject of the e-mail message, and the content as an attachment (not a link to browse the details). When the member initiates or accepts an instant message and elects to record it in their journal, the system records the date and time of the session, the participants, and a transcript of the session as an attachment (not a link to browse.) Similarly, when the member sends a fax and elects to record it in their journal, the system should record the date and time of the fax, the recipient(s), the status of the transmission, and the entire content of the fax as an attachment.

A system journal records and tracks certain important system events. Members are able to produce a report of the system journal entries for a date range. When another member changes a shared calendar event on a member's calendar, the system should record the original state of the event, the modified state, which initiated the change, the date and time of the change, and whether the member ultimately accepted or rejected it. This section is documented under Calendar section. The present invention should log every time that a member logs into or out of the system.

The present invention provides tools that enable associate users to administer the portal environment. Cleaning process is done for records that have been lying dormant for “60” days (configurable parameter). The record cannot be recovered again.

The present invention provides global access control list. Associate users are able to create, edit, and delete user accounts and to assign access rights to those accounts according to the roles they must fulfill. Because member users generally share the same basic privileges, this feature is required primarily for managing the rights of associate user accounts. The present invention allows associate users with appropriate rights to enable and disable user accounts. Disabling a user account is not the same as deleting it, and when a disabled account is re-enabled, it should have all the same rights and privileges it had prior to being disabled. E-mail, documents, journals, etc. are all preserved when a user account is disabled. The present invention allows associate users with appropriate rights to reset the password of a user account. The present invention allows associate users with appropriate rights to delete user accounts. Deleting an account should remove it from the system subject to a configurable grace period along with all e-mail, documents, journals, etc. owned by the deleted user. Deleting a user account does not remove records of interaction with the deleted user from the records of other users. Deleting a User Account means setting a flag to delete, only the background process will permanently remove the record after the grace period.

The present invention supports e-commerce capabilities to facilitate certain financial transactions between the system and its customers.

The present invention allows subscribers to pay their subscription fees online using credit cards or electronic funds transfer.

The present invention allows associates to credit the accounts of customers by performing ad-hoc “credit” transactions as necessary for account adjustments or refunds. Only certain associate users will have access to this facility.

The present invention provides a means by which divorced parents may record the details of their divorce decree as a “parenting plan”. The parenting plan is entered via the portal through a Web page like that illustrated in FIGS. 33 and 34. More specifically, an embedded “custody wizard” provides the information necessary to construct the custody calendar. Custody calendar information collected in the parenting plan is then added to the calendar, perhaps by importing it or by other more appropriate means as known to those skilled in the art.

The present invention supports the requirement that the custody schedule and terms of the parenting plan may vary over time (i.e.—visitation schedules may change from one year to the next, or child support amounts may decrease as children leave home).

A set of advisor tools, consisting of “dash board” summary and detail and ability to invite other users, is shown in FIGS. 30 and 31. The present invention provides several features to support the unique needs of advisors who may participate in the community (i.e.—attorneys and counselors). Advisors may use simple reports with which they can evaluate the performance of parents relative to the parenting plan entered in FIG. 33 and custody calendar. The present invention provides a report that presents a summary of parenting time, child support payments, shared billing, and the member journal for a given client as shown in FIG. 30. The present invention may provide additional reporting that presents a detailed view of activity for each of the summary sections indicated in the summary report above. Refer to FIG. 31 for a sample report. Additionally, the present invention provides a means by which advisors can invite clients to join while track the source of such referrals for special promotional pricing, rebates to referrers, etc.

The user interface of the community portal is implemented using a lowest common functional denominator approach optimized for the widest variety of client system capabilities. The user interfaces are thoroughly tested and verified to deliver multi-browser, multi-platform compatibility to the least of Netscape Version 4, Internet Explorer 4, or browsers implementing to support the HTML 3.2 specification.

The present invention integrates with several external systems to augment member services or back office operations. These systems and their primary purposes are: E-commerce, available for non-members; online counseling, present invention may peer with the online counseling resources or other similar sites to integrate content and for online counseling support; E-commerce transaction support and secure online payment processing; online customer support; an internet fax gateway service; financial services provided by third parties to support online child support payments and bill paying; accounting software for its back office financial operations; and interactive media tutorials developed by third party vendors.

The present invention is able to support multiple (more than 150,000 unique visitors) visitors each month, with this volume increasing at a rate of approximately 25% per year. Additionally, the present invention is able to support multiple (in one embodiment, a minimum of 250) concurrent user sessions at any single moment. A third party vendor may monitor server, application and network performance on an ongoing basis and proactively increase the capacity of the hosting infrastructure as required to maintain support for a concurrent user count of at least 20% greater than the maximum concurrent user session count recorded to date. The support for this traffic will be highly dependent on the hardware and software resources that the system and method of the present invention invests. The present invention is designed to work consistently with any given resources, but the performance of the application depends on the system resources, type of the database and network capabilities.

Thus, the present invention provides the tools for post-divorce parents to conduct responsible and accountable parental relationships for better economic and emotional security for their children. To achieve this objective, the invention offers features that specifically address the problems faced by divorced parents and their children. In a preferred embodiment, the following membership types and various levels of service may be provided.

“Email and Info Only” Account—users will have access to only the following: Talk (email only), Info (no RFL phone number, no telephone or online support), Kids content. Email and Info Only members do not have access to Calendar, Docs, Journal, Bills, Child Support, or Parenting Plan but instead can see the tabs with only the publicly accessible marketing content for each.

“Employee” Account—users will have access to all of the following: Talk (email only), Limited Calendar (a single intrinsic layer titled “Child Support” with transaction due dates and pay dates linked to transaction detail report), Info (no telephone or online support), Kids content, and Child Support (member child support tools). Employee members do not have access to Docs, Journal, Bills, or Parenting Plan, but instead can see the tabs with only the publicly accessible marketing content for each.

“Kids” Account—Kids will have access to all of the following: Limited Calendar (a single intrinsic layer titled “My Activities” and the “Parenting Time” layer of others if it has been shared with them; shared “Parenting Time” layers are read only; cannot generate a custody calendar), Talk (email only), Docs (without fax), Limited Journal (manual journal features only, no system features), Info (no telephone or online support), and Kids content. Kids do not have access to Bills, Child Support, or Parenting Plan but instead can see the tabs with only the publicly accessible marketing content for each.

“Basic” Member—will have access to the full capabilities of Calendar (including custody wizard), Talk (including email and forums), Docs, Journal, Bills (viewing, sharing, and payment), Info (including advisor search features and telephone and online support info), Kids content, Child Support, and Parenting Plan. A Basic member can add additional basic members, limited members, and kids to their account.

“Premium” Member—will have access to the full capabilities of Calendar (including custody wizard), Talk (including email and forums), Docs, Journal (manual and system features), Bills (viewing, sharing, and payment), Info (including advisor search features and telephone and online support info), Kids content, Child Support, and Parenting Plan. A Premium member can add additional basic members, limited members, and kids to their account.

“Basic Advisor” Account—will have Limited Calendar (a single intrinsic layer titled “My Activities” and any shared layers of other members), Talk (email only), Docs, Info (no telephone or online support), Kids content, and Limited Advisor Tools (Summary “dashboard” report only, no detail). Basic Advisor members do not have access to Journal, Bills, Child Support, or Parenting Plan but instead can see the tabs with only the publicly accessible marketing content for each.

“Premium Advisor” Account—will have Limited Calendar (a single intrinsic layer titled “My Activities” and any shared layers of other members), Talk (email only), Docs, Info (no telephone or online support), Kids content, and Enhanced Advisor Tools (Summary and Detail “dashboard” reports). Premium Advisor members do not have access to Journal, Bills, Child Support, or Parenting Plan but instead can see the tabs with only the publicly accessible marketing content for each.

“Basic Employer” Account—will have access to a separate interface that is specific to the setup and processing of employee child support payments, the addition of employee members, and reports. They will also have a link to the promotional version of the primary KnC site, with functionality similar to the “Email and Info Only” account described above. A Basic Employer member can add unlimited Employee members to their account.

Some upgrade options for expanded services, such as additional storage and additional accounts will be made available to subscribers.

The entire system is preferably implemented as a browser-based web application that does not require client-resident code components beyond a commonly configured web browser. For example, compatibility with Internet Explorer and Netscape is provided.

Terms of Use are accessible from within the system at all times via link included in the footer of every page once the user has logged into the system. A Privacy Policy is available to all users at all times via a link included in the footer of every page—including all publicly accessible content.

The user interface may be implemented in the English language only, localized for a combined U.S. and Canadian marketplace. Lists containing states for addresses include all U.S. states, territories, and protectorates, as well as all Canadian provinces—in each case using ISO standard 2-digit abbreviations. Currency values, where represented, are in U.S. dollars only. Additionally, the system may provide translated user interfaces supporting the Spanish, French and other languages, as well as localized currency support.

The system provides a means of registering new members-online. This will occur when a prospect elects to become a member, and when an existing member invites a prospect to join their personal community. This will preferably be done by incorporating a system available from a vendor, such as Rodopi, Inc. to handle all of the membership and promotion code features required.

All individual/original registrants must make a COPA Affirmation. Parents are required to register their children. This is done by adding the child membership to the parent's account. Adding a child member to a member's account is the only time that a COPA affirmation is not required. Registration of any other type of member requires a COPA Affirmation. Links to child friendly pages are provided that requests a parent's email address if COPA requirements are not met.

New users will be asked to identify the type of membership they wish to have, according to their role. For “Employer” and “Advisor” type accounts, the system administrator must be able to review and approve membership requests. The system will recognize the role of the member signing on as a “parent” or appropriate role so the appropriate dashboard is presented at log in. Each membership type should have a “link” that either opens a pop up window or goes to a system, window explaining each membership type, what is included, upgrade options, etc.

The registration information is submitted along with an optional promotion code, if the prospect has one. Before being allowed to pay, the potential member must first agree to the Terms of Use.

The prospective member will select a billing preference—either monthly or annual billing. The membership fee is calculated including any discounts, and presented to the user. The user will pay on line using Visa, MasterCard and Discover credit cards using the Authorize.net payment gateway or Electronic Funds Transfer (EFT) using a vendor service such as the Ventanex payment gateway.

Before gaining access to the system the first time, the user must make an election whether they wish to receive or opt out of one more newletters and special offers. Users are then further requested to specify the type of content they are most interested in from the following choices: Calendar, Email and Communication, Parenting Issues and Planning, Financial Issues, Legal Issues, Employer Issues, Children's Issues, Teen Issues, Record Keeping and Document Management, Counseling and Emotional Support.

Additional relevant information will be collected from employer and advisor registrants. At completion of registration, a confirmation will be presented to users along with their assigned fax # (if applicable), contact and support phone number/email, and RFL phone number (if applicable). The information presented on this page will be constrained as necessary according to the member type—some types will receive full support options while others will receive less. The information will be represented graphically as a “card” that can be printed and cut out by the user. All paid members will receive a page that shows the customer support number (basic or premium). Fax # will be an optional field they may manually fill in to “store” their fax number.

Promotion Codes for Affiliates, Employers and Advisors will be generated automatically by the system for all employers and advisors at the time of registration, for the purpose of tracking referrals. Also, if a visitor to the site comes from an ad, article or other place on another website, the system will detect and retain the identity of the source site (and any associated promotion code) for the duration of that visitor's session. Promotion codes will have to also be generated for Family Memberships so the “non paying” member can register as a separate individual in Rodopi.

The interface between the Rodopi system and the system site will allow for the necessary data exchange such that the system site will know of the membership status of each member and the behavior of the overall site will be as seamless as possible. Ropopi will be updated with “non-essential” data on an every two-hour basis. Changes to Rodopi information is immediately synchronized with system data.

After Rodopi registration is completed, members can “continue” to a system where they will enter user name/password information and other authentication information. Confirmation of registration will be emailed to each user upon completion. Verification of email address will not be required until they want to use the BILLS payment system. Members will also be prompted to “print this page” for their records.

After successful registration the user will be asked if they wish to log-in to use the site. Lost passwords will be emailed to an outside POP3 e-mail account provided by the user.

If a user completes the registration their provided email address, first name and password will be required for verification. Upon successful verification, they will be forwarded to a final registration page. If they can not be successfully verified, they will have to call the a system support desk who will be able to look them up in the system and walk them through the final process.

The system associates each membership type with a specific payment amount that may be unique and may vary over time, such as when a member upgrades their account by adding options such as additional storage, benefits, or additional members to their account.

The system associates payment amounts with a specific period of enrollment that may be chosen from multiple possibilities. The system also associates each member with their membership type, the enrollment period they selected, and the payment amount effective for that enrollment period at the time of their registration, the “bill-to” account (applicable when sub-accounts are created by the head of a family—see below), and the Promotion Code, if any, used by the member at the time of registration. (This information is accessible in an administrative report that can be generated by the system upon request of the system administrator.

Family Membership. A “family” includes the initial member who must be a Basic or Premium Member (Head of Family), plus 1 more Basic or Premium Member respectively, and zero or more Kid members. The initial member is the person who can create and add the other members as part of the family membership. The initial member is responsible for the payment of all fees due for the family and its members. A promotion code is generated upon the creation of a Family Membership that is then emailed to the other “adult” specified by the paying member. The code will be given in a template-email explaining that they have been included in this Family Plan and what they need to do to register.

If they ever desire to do so, additional Basic or Premium Members that have been added to another account can be removed from the Family Membership. If they are removed from the family membership (by the head of family), then the system must send an email notice stating that their account will become invalid in 30 days, (after expiration including on annual plans—they can not be canceled in the middle of the plan) and that they will be required to renew their account as an independent relationship at that time. The expiration date of their account must be updated to a future date that is 30 days in the future. On the expiration date, their account becomes invalid, and effectively cancelled. As a cancelled account, their account will be subject to the standard grace period that applies to all cancelled accounts, so that if they subsequently elect to continue their membership, they can henceforth be separately billed as an individual member, and their existing data will still be available to them.

The system provides a means by which registering members can enter a promotion code (only at the time of registration of a new membership or a renewal) that will be used to identify them as a referral from a specific referral partner, a response to a particular advertisement, or to qualify them for special promotional pricing.

A promotion code is valid until a membership expires. The ‘types’ of promotion for the purpose of this requirement are a Referral Promotion, which associates a user with a specific advertisement, partner, or association for the sole purpose of tracking referrals and response rates, and a Discount Promotion, which provides a discount on all fees billed to the member. Also a promotion code will be assigned to all Family Plans to facilitate the individual registration of the “second adult” on the plan. Have not seen this functionality yet.

Promotion codes are assumed to be valid for use by more than one prospect or member and can therefore be presented more than once as long as they are otherwise valid. However, a “one time use” flag can be set when the promotion code is created, and if this flag is set, then the promotion code can be used once and only once by a single member.

Valid Member Types—To prevent misuse of promotion codes providing high discounts or free memberships, it will be necessary to identify the membership types for which a promotion code can be used, by for example, setting a parameter (variable) that a promotion code will not be accepted for specific membership types. Any promotion code that is submitted by a first-time registrant or renewing member is validated at the time of registration and any related discount must be applied to the payment amount charged to the user.

Each account will reference a “Bill To” account. This is usually the same person that is the account holder. However, in the case of a Family Membership, this will be the head of family—that is, the person who initially enrolled, electing to purchase a Family Membership. The Billed To account will be responsible for payment of all fees for any accounts billed to them. Upgrades may be purchased separately from others on Family Plans. Bill To will only refer to the basic subscription and any upgrades purchased by that individual.

When any promotion code results in a 100% discount (effectively a free membership), then the system must not attempt to charge the $0.00 amount. Instead, it should simply indicate that there is no fee due and proceed as though the required fees have been paid in full.

An Annual Prepaid Membership will expire on the 1 year anniversary of the original registration date. A Month-to-Month Membership will not expire based on any calendar date, but will expire only in the event of cancellation by the member, or failure to collect fees due as recurring financial transactions processed by the system's payment processing partner.

Thirty (30) days prior to the expiration of any Annual membership, the system will send an email reminder to the user stating that the membership will expire in 30 days and inviting them to renew their membership. If the initial enrollment period expires and the member has not renewed or cancelled their membership, their billing method will then default to month-to-month and will continue this way using the payment information on file with the system payment processing partner until the user specifically cancels or renews and pre-pays their membership.

Cancelled memberships will be subject to a grace period so that they can renew their membership within 60 days and still have access to all of their data that was previously available to them online. After this period of time, the ex-member's data may be purged from the system according to the cancelled user account grace period.

Member Invitation—Members will be able to invite prospects to join their personal community. The system will email an invitation message including registration instructions to the prospect. If the prospect registers, the system will send an e-mail notification of the registration to the member who initiated the invitation. The system will ‘track’ referrals made in this manner by recording with any registration, the user account ID of the referring member. An invitation made in this manner can be sent by a member, and may not come from non-members. An invitation can be sent to any valid Internet email address. To invite a prospect to join, a member must provide only a valid email address. No other information is required.

The system will implement security measures that enforce the individual authentication of all users. Users must be required to log in to the system to access all member services. Upon successful initial login and authentication, all users will be presented with the Correct user Dashboard based on their membership type. If a user attempts to access a particular resource from within the system after already having successfully logged in, but after a period of time sufficient for their authentication to expire, the system will force them to log in again, and then redirect them upon successful authentication to the resource they were requesting.

Lost Passwords—The system will provide a means by which users who have misplaced or forgotten their passwords can retrieve them without the assistance of support personnel. Upon the request of an unauthenticated user who enters a valid user account ID, the password hint question on file for the account will be presented to the user. If the user answers the hint question correctly, then the password is e-mailed to the member's e-mail address of record that was provided by the member during registration. Some users' sole e-mail account may be their system account which, in the case of a lost or forgotten password, will not be accessible to them. Such cases will require that system help desk personnel reset the users password for them.

The system will provide a simple personal database of contacts for member and associate users. Address Book Entry and Editing—Members will be able to create, edit, and delete entries in their personal address book. Address Book Groups—Members will be able to create groups within their address books.

Address Book Entry Forwarding—The system provide a means by which members can forward address book entries to other members and to non-members. When a person is invited to a personal community and he/she accepts the invitation, that person's profile is added to the address book of the person who invited him/her.

The system will provide a web-based e-mail service for member and associate users. All member and associate users will have system e-mail accounts. Support for SMTP mail delivery outside the system community will be provided. The e-mail feature will support composing and sending new messages, replying to messages, and forwarding messages.

The system will provide support for organizing e-mail messages into folders. The system will allow users to create, delete, and rename folders at their discretion. The user's personal address book will be accessible from within the e-mail program such that one or more address book entries can be selected when composing and addressing email messages.

The system will allow users to optionally forward all internal system e-mail and notifications to a single external e-mail account. The system will provide a means by which pre-defined e-mail templates that can be employed by members to quickly create e-mail messages based on predefined content. Email templates will be created and provided by the system. The system will allow users to select a template from a collection of available templates when composing a new email message or replying to an existing message. The email message body will be populated with the content of the template to be further composed or edited by the user before sending the message. A simple listing of available phrases and other content that the user might chose to copy into their messages will also be made easily available. The content for this list will be provided by the system and will be stored in the content management system, so that system administrative staff can easily maintain the content.

If the data storage space is full for a particular user when an email message is sent to them, the message will not be delivered and the sender will receive an email stating that the email space is full and the message cannot be delivered. The default functionality for outgoing mails should automatically save the outgoing messages in the Sent messages folder. An option in Email Preferences should allow users to disable the default saving of outgoing messages. The system will automatically scan inbound email messages for virus-containing content.

Email Attachments—The system will support the inclusion of multiple file attachments to an email message. The system will support uploading and attaching files from the user's computer, or attaching files from the users personal document archive in the system. Users will be able to open and view email attachments within their browser window, provided the attachments are of a suitable format for browser display. Users will be able to download attachments to their computers, or move them to a folder in the personal document archive in the system. Attachments will also be able to be opened and used to an attachment for a new Bill. The Bill does not have to be created prior to linking to the attachment, but does need to be completed and saved in order for the attachment to be properly linked.

The system will enforce storage quotas for user data storage space. A user's data storage space is the total allocation of database storage space that is available for use by the user for any purpose. All data including e-mails, documents and files, calendars, and logs contribute to the total use of this space.

Members will be allocated an amount of data storage space according to their membership type. Any member may increase their allocation of data storage space by purchasing more space at any time. This can be done at the time of initial registration, or later by upgrading their account by adding additional storage in “My Account.” Fees for additional storage will be added to any fees already being billed to customer, using the same frequency of billing and the same payment method. When a member who pays fees annually purchases additional storage space, they are charged at the time they initiate the upgrade. Pro-rating of fees for membership, options, or any other purpose can be implemented. A member who is currently on a family plan under a “token” as billed to another member, may purchase upgrades for their space individually, since their account is recognized on an individual basis.

Additional data storage space will be sold in blocks of a fixed size for a fixed price. The system will provide a report of space used and available in the user account summary under “My Account”.

The system will provide a means by which parents can record the details of their divorce decree as a “parenting plan”. The parenting plan and, more specifically, an embedded “custody wizard” will provide the information necessary to construct the custody calendar. A series of Parenting Plan wizards will outline the “rules” of the custody calendar for both parents and implement these rules, upon agreement in the “parenting time” layer of the calendar. All information collected in these wizards will be stored under the parenting plan tab for future edits and review. A series of questions will assist a user in creating a complex custody calendar.

Schedules and Terms Vary over Time—The system supports the requirement that the custody schedule and terms of the parenting plan may vary over time (i.e.—visitation schedules may change from one year to the next, or child support amounts may decrease as children leave home).

A “Shared Bills Wizard” will ask the user a series of questions to help members create default settings for sharing bills according to the terms of their divorce decree. Also, each child will have a unique Parenting Plan and it will also be possible to group children into a common Plan. It will be possible to copy the Parenting Plan of one child to facilitate more quickly creating the parenting plan for another child. It will be possible to share some Parenting Plan information with other members.

When the Custody Wizard is used to create or modify the Parenting Plan, approval of the entire plan or change will be required from the other party at one time. If the other party does not approve the plan, then a reason must be given. Any changes to address the stated objections would be made by the originator, and then would be presented for full approval again.

The system will provide a calendar feature that enables member and associate users to manage their time and important events. Calendar Event Entry and Editing—The system will enable users to enter, edit, and delete individual events on their calendar. Calendar events will include the following information: Event Description, Date, Time, Duration, Category (such as Business, Personal, Custody Event, Religious, School, Family, Holiday, etc.), and Notes. The user will have the ability to add new calendar event categories.

Event Reminders—The system will enable users to set reminders to occur at a specified interval before the event start time. Reminders will be sent (at user's option in Calendar Preferences) via e-mail to any address specified in the user's calendar preferences or displayed onscreen. Event reminder can also be an audible signal and pop up reminder.

Recurring Events—The system will support the entry of recurring calendar events, including recurring events that have multiple start and stop dates/times. It must also support periodic exceptions to the recurrence schedule. Overlapping start and stop times will not be allowed at the time of data entry. Instead, users must be notified of such conflicts and given an opportunity to correct them.

Editing Events—When a single event is edited, the changes are applied to that event only. If the change is made to a recurring event, then the member will be asked to specify whether the change should be applied to the single event, or the single event and all future events.

Multiple Calendar Views—the Calendar will provide Daily, Weekly, and Monthly views. It will be easy to switch between views and when doing so, the system will maintain date context between views.

Calendar Event Categories—The system will allow users to associate an event with a specific event category. Two pre-defined special purpose event categories are supported—“Child Support” events and “Parenting Time” events. Users will be able to create, rename, delete, and assign categories at their discretion. Users will not be able to rename or delete the “Child Support” and “Parenting Time” categories.

Child Support Calendar Events—The system will support a unique calendar event type for child support events. Such events represent child support payment events such as a child support payment that is due, a payment that is made, and a payment that is received. Private child support payments (between parents without government involvement) will be treated like another recurring P2P bill (Parenting Plan agreement with recurring pattern).

Custody Calendar Events—The system will support a unique calendar event type for custody events. These are titled “Parenting Time”. Such events represent the schedule for child custody according to the “custody calendar”. Custody events are shared by co-parents and are used to manage the custody of the children. Clear visual indications of which parent has custody of each child is provided. “Mousing” over any child icon will reveal the detail of the custody schedule for the child for the current date in a hover window. In the monthly and daily views of the main calendar, there is preferable no color-coding of days to indicate Parenting Time. Rather, this will be indicated entirely through the use of the child icons.

In-built Holidays—The calendar and the custody wizard will provide a collection of common holiday sets such as government and religious holidays (i.e.—Jewish, Christian, Muslim holidays). Because of a virtually unlimited number of possible variations, this feature set will be generalized into a set of tools that will enable the staff to initially populate and subsequently update this collection.

Calendar Layers—The system supports calendar layers whereby the view of a user's calendar can be customized by enabling or disabling the display of one or more “layers” at any time. Calendar layers correspond to calendar event categories, so a layer will exist for each user-defined event category and for each of the pre-defined categories of Child Support and Parenting Time. The list of layers to be displayed will be available in each calendar view.

Calendar Sharing—The system supports the sharing of a user's calendar with members of his/her personal community. The system provides the ability to share a member's entire calendar, one or more layers of a member's calendar, one or more events in a member's calendar, or any combination of the above 3 items. Members are able to share their calendars with 1 or more members of their personal community, and with all members of their community.

Calendar Access Control—The system provides a means of calendar access control whereby individual users can control how members of their personal community access their calendars. Access levels assignable to layers or single events should include: No Access, Read-Only Access, and Read/Write Access. Rights can be assigned to an individual or a personal community. There are preferably no other permission groups within the system. Access level assignments for individual events or members (more specific) will override assignments for event categories/layers or the community (more general).

Pending and Permanent Events Status—The calendar will support a pending status for an event that has been placed on the shared calendar of a member by another member, but has not approved by the calendar owner.

Event Hiding—The system will allow users to “hide” events on their calendar such that any event so hidden will not be visible to any other user, even if it exists in an event category/layer that is shared to other users. This is provided using a checkbox and it will override all other permissions.

Adding Events to Another Member's Calendar—This is an invitation scenario. It is not the same as having Read/Write permissions—The system will enable users to submit events for inclusion in the calendar of any member of their personal community who has granted this permission to them. This mechanism allows members to invite others to events. When a member submits an event to another's calendar, the event will initially be added to the recipient's calendar as a pending event (meaning “unconfirmed”) until the recipient confirms their acceptance of the event. When a user submits an event to another's calendar, the recipient will receive e-mail notification of the event. When the recipient responds to the notification, either by accepting or declining the event, the submitting user will be notified of the outcome by e-mail. If a recipient declines the event, then the pending event will be removed from their calendar. A decline of an event should be accompanied by a reason. If the originator decides to modify the event to attain approval, the process starts over.

Submitting Custody Events to Another Member's Calendar—When custody events are submitted to the calendar of another member/parent, both parents must agree to a custody event. Prior to acceptance by both parents, these events are “pending”. This status cannot be manually overridden by the user. In a case where a custody calendar is not shared between two parents, it is possible that the parent/member who originates the custody schedule may approve it unilaterally. However, if the other parent subsequently joins the system community and the custody calendar originated by the first member is then shared with the second, then the second parent must have an opportunity to accept the event schedule. If the event is not accepted, a reason should accompany the rejection. If the originator decides to modify the event to attain approval, the process starts over.

Custody Event Change Logging—The system will log all changes to any shared custody event. This is stored in the System Journal.

Printing the Calendar—The system will enable users to print a “printer friendly version of their calendars in month, week or daily views. The daily calendar view will be set to display a day that begins at 6:00 am, and will do so unless there is an event on the calendar that day that occurs at an earlier hour. If there is such an event, the day display will begin at the hour of the start of the events on that day.

Calendar Preferences—The system provides a means by which a user's personal calendar preferences are quickly and easily managed. Such preferences will include the calendar layer access controls as described above, the e-mail address for delivery of event reminders, default reminder time (that is, how far in advance of an event to give reminder), enable/disable custody event change logging, the startup view (month, week, or day) and layers to show.

The system will provide basic forum support that will be accessible from within the Talk section of the site. This forum will be available to anyone within each member's community, and they will be able to select which members of their community can participate.

The system will provide a means by which members can maintain a personal archive of documents, images, email, etc. that are stored in the system database. Preferably, all uploads will be through HTTP, not through FTP. The only file size limitations that will be a factor are the amount of available space remaining in the member's data storage space quota and the technical limitation of the HTTP protocol.

Organizing Documents—The system provides support for organizing documents into folders. Folders may be added as desired at the discretion of the user. The system provides a means by which folders can quickly and easily be created, deleted, and renamed, and will support nested document folders.

Uploading Documents—The system allows users to upload files from their computers to include them in their personal archive.

Receiving Faxes—The system allows users to include faxed documents in their personal archive if they are subscribers to one of the available fax services. These faxes will arrive as attachments to email messages, and will be saved in Docs folders like other attachments. The Inbox will display a visual indication that differentiates fax messages from the others. In order for this to function properly, the user will have to inform system of their fax provider so it can recognize the source of the incoming fax so it will filter properly.

Forwarding Documents—The system allows users to forward documents from their personal repository by e-mail and fax. This capability implemented by a commercial fax gateway. Forwarding documents via fax involves emailing them to a specified email address. Attachments are filtered to include only supported file types. The system fax partner will typically require a frequently updated list of users identified by their account ID and a PIN number that can be used to validate users prior to granting access to telephone support and also to bill user accounts for faxing services.

Sharing Documents—The system supports the sharing of a user's personal archive with members of his/her personal community. Shared documents will not be copied, but instead will be referenced by pointers. Personal Archive Access Control—The system provides a means of access control whereby individual users can elect to allow members of their personal community to access resources in their personal archive. Varying levels of access will be assignable to other members by folder, or more discreetly by each file individually. Access levels assignable to folders or single files will include: No Access, Read-Only Access, and Read/Write Access. Access level assignments for individual files preferably override assignments for folders.

Hiding a File—The system allows users to “hide” a file in their archive such that any file so hidden will not be visible to any other user, even if it exists in a folder that is shared to other users.

Personal Community Management—The system allows members to invite others to join their personal community. Additionally, members will be able to permanently remove another from their personal community at any time. Once another is permanently removed from a member's personal community, it is required that all access rights assigned to that person be retained by the system and recoverable for up to 30 days. However, they would remain in the address book and any historical records of interactions with them (i.e.—e-mail, shared events, instant messaging sessions, etc.) would be retained indefinitely.

Temporary Disablement of Personal Community Rights—The system allows members to temporarily disable the participation rights of any member of their personal community. In this manner, a member is able to temporarily suspend all rights of an individual including their access to all shared resources until they are re-enabled at some future time. When suspending personal community rights in this manner, the system maintains the prior state of all sharing and access rights and privileges so that they can be immediately returned to that prior state upon re-enabling personal community rights.

Personal Access Control—The system provides two methods in which a member can easily assign and modify access rights to members of their personal community across all shared applications. Individual access control settings will be available from the contact records of individuals in the address book, and access control settings for all members of a personal community will be accessible from a “My Community” sub navigation item under “My Account”.

Personal Profile Management—The system allows members to access and modify their own personal profiles that they created at the time of registration. The system provides a summary of account information (in “My Account”) including all members associated with the account, the bill-to contact for the account, the active payment plan, options, and promotion code (if applicable), the ability to add new members to the account, and the ability to upgrade the account by adding options to the account. Survey questions could be provided and managed and users could change their answers to reflect their content needs.

Cancellation of Global Community Membership—Members are able to cancel their membership in the global community at any time. In the event a member cancels their membership, they will lose all rights to access the system but the system will retain their data, preferences, and history for 60 days. In the event the member rejoins the community, all of this information will be recoverable so that the member's resources can be returned to their prior state.

The system will provide support for the creation, management, sharing, and payment of miscellaneous bills. Bill presentment and payment features will run under HTTPS.

Creating Bills—The system supports the creation of a bill by two methods. In the first method where a physical bill is present, the bill document may be scanned and uploaded or faxed into the member's personal file archive then a bill can be created from it by entering the bill properties. The original bill can then be “attached” to the newly created bill as a reference document. In the second method, where a physical bill is not present, the member will simply enter the bill properties and the bill record will not contain a viewable representation of the physical bill.

When a bill record is created, it should contain the following information: Payee, Received Date, Bill Description, Original Amount, Shared?, Percentage of Total to Share, Amount Due, Amount to Pay, Original Due Date, Scheduled Pay Date, Bill Category, Paid?, Payment Method, Payment Date, Transaction ID, and Notes. If a bill represents a child support payment that is due, then its properties are extended to include a Case #, and Disbursement Unit, and whether or not it is paid by an employer.

Child support payments will appear in the list of bills (Inbox until paid, and then outbox). If the bill is to be paid by an employer, the bill is only shown for reference purposes and no action is required by the member. Such bills are only read-only.

Bill Reminders—The system will provide a bill reminders feature that will optionally remind members when a bill is due and must be paid. Bill reminders will be sent to an e-mail address specified by the member for the purpose of receiving notifications and reminders.

Sharing Bills—Members are able to share bills with other members in their personal community. Bills may be shared in any ratio defined when the bill is shared. The amount shared can be specified as a percentage of the original bill or as a fixed amount. When a bill is shared between members, two bill instances are created—one belonging to each of the members. The lifecycle of these independent bill instances are unique and separate.

Members are able to accept or decline a shared bill. When a shared bill is accepted or declined by a member, an email must be sent to the originating member advising them of the occurrence. Members will be able to pay shared bills direct to one another and to payees as necessary using the Ventanex payment gateway.

The “Shared Bills Wizard” of the Parenting Plan will determine preset %'s for certain types of bills discussed in the divorce decree such as medical, school expense, extracurricular activities, higher education funding, etc. Shared Bills “Wizard” will show a list of Bill Categories that includes all of the following pre-defined categories, PLUS allow the user to add additional ones.

Bill categories include: Medical Insurance, Medical, Extracurricular Activities Household, Auto, Travel, Real Estate, Mediation, Counseling, Clothing, Dental Insurance, Dental, Education, Childcare, Religious, Vision, Extraordinary, etc.

Adding Bills to the Calendar—The system supports an “add to my calendar” property for bills whereby any bill can be added to the member's calendar. When a bill is added to the calendar, a bill payment reminder is added to the calendar before the bill's scheduled pay date. The lead time provided by the reminder is based on the reminder lead time preference defined by the member in their bill payment preferences.

Reviewing All Bills—Members are able to view a list of all bills that are unpaid, a list of bills that are scheduled for payment, and a history of bills that have been paid. Viewing a Single Bill—Members are able to view the details of a single bill. If a bill image is available, then it must be presented with its accompanying information. Editing Bill Properties—Members are also able to open and edit the properties of their bills.

Paying Bills—Members are able to pay their bills online by EFT, using the Ventanex payment gateway. If payment is to be made by off-line methods, such as personal checks, money orders or cash, and each member will be able to enter associated information, such as check number, and the payment will be recorded. If the payment is in relation to a Shared Bill, the system will confirm payment to the member recipient, along with the associated appropriate information about the payment.

Managing Payees—The system provides a means by which members can create and manage a collection of payees to whom they may pay bills from time to time. Bill Payment Preferences—Members are able to define their preferences relative to bill payment activities. For example, they will be able to maintain a list of user-defined payee categories, expense categories, payment methods and accounts, and reminder lead time preferences.

Content Management: The site is provided with basic content management features that will allow the system to easily upload and manage site content items. These content items will be stored in a database and will be served dynamically as the associated web pages are called. This may be implemented using the RedHat CCM toolset, and will support version control. Templates are provided for the Home Page, the Info Page and the Kids pages, where the bulk of this content will be presented, to effectively separate the content from the presentation elements of the page. This content is searchable on the site.

The system provides features that facilitate the placement, rotation, reporting, and billing of online advertisements within the site. These features are available only to system users with appropriate access rights. Ad Placement—Admin users will be able to define the placement of specific advertisements into various pre-defined locations throughout the site. Ad Rotation—Admin users will be able to define ad rotation such that a single advertisement may display in multiple locations, or multiple advertisements may display in a single location. Ads will be handled as CMS objects within the Content Management System.

Ad Reporting—Admin users will be able to produce reports that detail by-advertisement information such as the number of ad impressions, and click-through rates/ratios for a specified time period.

Ad Billing Data Export—The system provided a means by which advertiser information, ad impression counts, click-through counts/ratios, etc. can be translated into billing data and exported in a file format that is appropriate for import into the Plus & Minus accounting system.

The system preferably includes a knowledge base that provides online help to users, facilitating their use of the community portal. Knowledge base content is stored as questions and answers and searches will be based on questions and answers.

The system allows members to maintain a journal of entries that will be saved in chronological order. These events will either be created manually, or will in some cases be generated automatically by the system. The system will allow the user to sort and filter this journal listing in several ways.

Members are able to create, edit and delete journal entries including the following information: Date and Time of Entry, Short Description, Notes, and file attachments. At the user's option, the system will record certain application events in the journal. For example, When the member sends an email message and elects to record it in their journal, the system will record the date and time the message was sent, the addressee(s), the subject of the email message, and it's entire content as an attachment (not a link) to browse the details.

When the member sends a fax and elects to record it in their journal, the system will record the date and time of the fax, the recipient(s), the status of the transmission, and the entire content of the fax as an attachment. When membership privileges include the system journal features, the system will automatically create journal entries for various events and activities, such as shared calendar event changes and member login/out history, in the system.

Any system-generated journal entry can be subsequently edited by the member, so that comments and/or attachments can be added. Members will be able to produce an onscreen report of journal entries for a date range. The member will be able to filter and sort this report. The member will be able to print the onscreen report at their option.

The system will integrate (using URL) with third party partners who will provide basic shopping cart functionality with the ability to pay for product purchases using credit cards online. Amazon, Cafe Press, B-Safe Online, LifeGuard Benefits.

The system provides several features to support the unique needs of advisors who may participate in the community (i.e.—attorneys and counselors). This information and functionality will be presented on a separate “Advisors” page of the site.

Advisor Reports—The system provides simple reports (the “Dashboard”) with which advisors (i.e. attorneys) with appropriate access rights can evaluate performance of parents relative to the parenting plan and custody calendar.

Advisor Summary Report—The system provides a report that presents a summary of parenting time, child support payments, shared billing, and the member journal for a given client.

Advisor Detail Report—The system provides additional reporting that presents a detailed view of activity for each of the summary sections indicated in the summary report above

The system associates advisors with their clients by, for example, using the invitation/acceptance mechanism described above. All advisors see their “summary” dashboard, but data is only available if clients have shared the associated applications.

Advisor Referrals—The system enables advisors to invite clients to join while tracking the source of such referrals for special promotional pricing, rebates to referrers, etc.

Advisor Directory—The system provides a searchable database of advisors. Search criteria will include advisor type (advisor's area of practice), city, and state. The advisor directory presents search results in a tabular summary listing with a paging navigation mechanism to facilitate browsing of the listings by the user. Premium advisors matching the search criteria will be highlighted and presented at the beginning of the search results list alphabetically in ascending order by name of practice, with other advisors following alphabetically in ascending order by name of practice.

The advisor summary listings that are presented in the search results screen are implemented as links to a detailed listing of information about the advisor that is presented in a new browser window.

The Affiliates section of the site is preferably constructed using the RedHat CCM toolset to include Affiliate “sub-sites” that will present Affiliate content to their referred members when those individuals log in to the system, and allows Affiliates to create and upload content directly to their pages. This process will include workflow controls so that such content is approved by system administrative staff prior to publishing.

The system provides features that enable employers to manage the online payment of child support withholdings. This is accessed by employer members through a separate interface, tailored specifically to their unique needs.

There is a single “Employer/Company” account with the ability to create sub-accounts for separately creating and approving payments as a check/balance feature. At employer's option, this check & balance feature could be disabled such that only the single “Employer/Company” account could be used for all purposes. At least one employer member for each company will have “Employer Admin” capabilities providing the ability to create, edit and delete additional employer member accounts associated with the same company.

Create Employee Accounts—Employer administrators are able to create member accounts for employees of their company. This can be accomplished by creating child support case records; that will create an employee account.

The Child Support system will create ACH payment files that will be uploaded to the ACH network through the Ventanex payment gateway or (at the option of Employer) may be downloaded by the employer member and submitted outside of the system to their own bank. Employers will have the option to download fully formatted “fed-ready” ACH files for manual submission to ACH processor of choice by employers. In either case, the payment data will be formatted appropriately for the requirements of the associated Disbursement Units.

When an employer plans to submit payment through the Ventanex payment gateway, an initial “test” transaction will be sent as a “pre-note” transaction or a “zero-dollar” transaction to verify the setup of the employer, and the SDU file formats for the SDUs required. The system will hold new employer accounts in a “New” or “Testing” status until manually released by a system associate to an “Approved” status before the employer can submit payments.

The system will provide to system associate members (with appropriate access permissions) a view of employer accounts and their test status, and should provide a means by which the associate user can modify their status. Statuses include “New”, “Testing”, “Approved”, “Hold”.

Employee Case Setup—Employers will be able to setup case records for each employee for whom they withhold and pay child support. Employers will be able to specify on an individual case basis whether they would like to receive transaction status updates via email.

Initiate Payments—Employers will be able to initiate child support payments by providing a Pay Date, a Settlement Date, and an SDU Deposit Date. Once this required information is provided, employers will be able to select specific cases for payment, or optionally, select all cases then initiate payment. The employer's selection is saved and will be repeated accordingly.

Authorize Payments—The system may require a two-step child support initiation and authorization process whereby one user initiates payments and another must authorize them. This may be overridden in the case where an employer has only a single Employer Admin user.

Review Employer Payment History—The system provides a means by which employers can view a history of all payments initiated. Such a view will include the status of a payment, the pay date, the settlement date, the withholding amount, the number of cases, the SDU deposit date, and the date the payment was initiated. Employers will be able to select a specific employer payment and view its detail.

Review Employer Payment Detail—The system provides a view in which employers can view the details of a specific employer payment. If the status of the payment is appropriate for such action, employers should be able to authorize or stop payments here. Whenever a detailed report is requested, it will be secured by comparing the member id submitted with the member id stored in the session.

Payment status information will be communicated appropriately to the associated payer and payee members of the site.

This Ventanex child support payment gateway will also be implemented so that members can make their child support payments themselves in those cases where they are not obligated to have their employers make these payments. At the time each payment is submitted by the user, the system writes two records into a database. The first is to transfer the funds from the payor to an escrow account. The second is to handle the other part of the transfer—from the escrow account to the payee.

Once per day, an encrypted batch file of scheduled debits is uploaded to Ventanex. An associate bank will debit the payor account and mark any error in debit, such as for insufficient funds. Payments from the successfully debited accounts are transferred to an escrow account held at the associate bank. These records are downloaded to the system. These reports are processed to associate the tracking numbers, return codes and error codes with the payment records. Successful payment notices and error messages are presented to the respective payors (and as appropriate, payee). In the case of an error, the payment will have to be resubmitted by the payor after the error is corrected. Finally, for successful payments, the amounts are credited to the accounts of the respective payees, and the appropriate notice will be posted to the payee.

Basic and Premium Members are to setup a child support “case” and pay child support as an employer does. Basic and Premium Members are able to specify in their Child Support Preferences whether their employer pays child support on their behalf or whether they pay it themselves.

All members, including those who pay their own child support and those whose child support is paid by their employers, will be able to view the histories and status of their own child support payments as described for employers above, except that members will not be allowed to view any information that is related only to the employer or to other employee cases. Members will be able to specify in Child Support Preferences whether they would like to receive updates of child support transaction status via email.

The system will provide tools that enable admin users to administer the portal environment. Global Access Control—The system will provide a global access control list. Associate users will be able to create, edit, and delete user accounts and to assign access rights to those accounts according to the roles they must fulfill. Because member users will generally share the same basic privileges, this feature is required primarily for managing the rights of associate user accounts.

Enable/Disable User Accounts—The system will allow associate users with appropriate rights to enable and disable user accounts. Disabled accounts means that the user cannot log in. Disabling a user account is not the same as deleting it, and when a disabled account is re-enabled, it will have all the same rights and privileges it had prior to being disabled. E-mail, documents, journals, etc. are all preserved when a user account is disabled.

Reset User Account Password—The system will allow associate users with appropriate rights to reset the password of a user account. Delete a User Account—The system will allow associate users with appropriate rights to delete user accounts. This will be performed by an administrator and will require clear confirmation first.

Summary Financial Data Export—The system provides a means to export summary financial data (as journal entries) in a file format that is appropriate for import into the Quick Books accounting system used by the system.

Member Data Import—The system provides a means to import new member data to facilitate the setup of large numbers of new members at one time.

Promotion Code Reporting—The system provides reports of total membership and new membership activity organized by promotion codes to facilitate the tracking of referrals, compensation of referral partners, the performance of marketing promotions, or for billing or other purposes.

A separate administrative user permission set is created for the customer support operation to allow them to perform necessary limited administrative functions, such as changing passwords. As needed, separate administrative interfaces for these users will be provided.

The system will integrate with several external systems to augment member services or back office operations. These systems and their primary purposes may include:

KidsHealth (www.kidshealth.com); Rodopi, Inc. (www.rodopi.com); Ventanex (www.ventanex.com); Authorize.net (www.authorize.net); QuickBooks (www.intuit.com); Amazon.com (www.amazon.com); CafePress (www.cafepress.com); SupportKids (www.support-kids.com); Martindale-Hubble (www.lawvers.com); Big Chalk (www.biqchalk.com); Brain Pop (www.brainpop.com); Super Pages (www.superpages.com); CCCS of Atlanta (cccs.org); LifeGuard Benefits (www.lifequardbenefits.com); B-Safe Online (www.bsafeonline.com)—

Although the present invention and its advantages have been described in detail, it should be understood that various changes, substitutions and alterations can be made herein without departing from the spirit and scope of the invention as defined by the appended claims. The invention achieves multiple objectives and because the invention can be used in different applications for different purposes, not every embodiment falling within the scope of the attached claims will achieve every objective. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for facilitating complex familial interactions, comprising the steps of:
providing an internet-accessible database and functions;
enabling access by users to said database and functions; wherein any user may specify additional users to be members of a personal community of the user;
enabling one or more members of a personal community to share information with one or more other members of the community.

2. The method of claim 1, wherein a specifying user may remove a specified member from the user's community.

3. The method of claim 1, further comprising the step of:
enabling a user as a payor to order payment to another user as a payee;
debiting an account of the payor for an amount to be paid to payee; and
crediting an account of the payee of the amount.

4. The method of claim 1, wherein the specifying user further specifies what information is to be shared with each one of said one or more members.

5. The method of claim 1, wherein the information to be shared includes data relating to conformance with a court order.

6. The method of claim 5, wherein the data concerns child visitation.

7. The method of claim 5, wherein the data concerns child support payments.
